(19) United States
(12) Patent Application Publication
(10) Pub. No.: US 2025/0323759 A1
(43) Pub. Date: Oct. 16, 2025

(54) IDENTIFYING UNSUCCESSFUL TERMINATIONS OF HYBRID AUTOMATIC REPEAT REQUEST PROCESSES

(71) Applicant: QUALCOMM Incorporated, San Diego, CA (US)

(72) Inventors: Mostafa KHOSHNEVISAN, San Diego, CA (US); Jing SUN, San Diego, CA (US); Sherif ELAZZOUNI, San Diego, CA (US)

(21) Appl. No.: 18/634,826

(22) Filed: Apr. 12, 2024

(51) Int. Cl. H04L 1/1812

(52) U.S. Cl. CPC H04L 1/1812

(57) ABSTRACT

Various aspects of the present disclosure generally relate to wireless communication. Some aspects more specifically relate to a user equipment (UE) detecting an unsuccessful termination of a hybrid automatic repeat request (HARQ) process (for example, due to a negative acknowledgement (NACK) to acknowledgement (ACK) error) associated with a transport block, and reporting the unsuccessful termination of the HARQ process associated with the transport block to a network node. For example, the UE may detect and report instances where a transport block associated with a HARQ process identifier is not decoded and the UE receives another transport block associated with the same HARQ process identifier. Additionally, the UE may detect and report instances where a transport block associated with a HARQ identifier is associated with a new data indicator value that is different from an expected value.

### FIELD OF THE DISCLOSURE

Aspects of the present disclosure generally relate to wireless communication and specifically relate to techniques, apparatuses, and methods associated with identifying unsuccessful terminations of hybrid automatic repeat request processes.

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

In some wireless communication networks, devices (for example, a user equipment (UE), a network node) may perform a hybrid automatic repeat request (HARQ) process to improve a reliability of communications exchanged between the devices. For example, a transmitting device may send a transport block (for example, data) to a receiving device, and the receiving device may attempt to decode the data. In cases where the receiving device successfully decodes the data, the receiving device may transmit a HARQ acknowledgement (ACK) message to the transmitting device. Additionally, in cases where the receiving device fails to successful decode the data, the receiving device may transmit a HARQ negative ACK (NACK) message to the transmitting device. In some cases, a transmitting device may incorrectly detect an ACK message in instances when the receiving device indicated a NACK message. Such errors may decrease a reliability of communications between the transmitting and receiving devices, may introduce latency into communications between the transmitting and receiving devices, or may otherwise degrade a quality of the communications between the transmitting and receiving devices.

### SUMMARY

Some aspects described herein relate to a method of wireless communication by a user equipment (UE). The method may include receiving, from a network node, control information scheduling a first transport block and indicating that the first transport block has a same hybrid automatic repeat request (HARQ) identifier as a second transport block. The method may include identifying an unsuccessful termination of a HARQ process associated with the second transport block in response to a failure of the UE to successfully decode the second transport block, the control information scheduling the first transport block having the same HARQ identifier as the second transport block, or both. The method may include transmitting, to the network node, signaling indicating the unsuccessful termination of the HARQ process associated with the second transport block.

Some aspects described herein relate to a method of wireless communication by a network node. The method may include transmitting, to a UE, control information scheduling a first transport block and indicating that the first transport block has a same HARQ identifier as a second transport block. The method may include receiving, from the UE, signaling indicating an unsuccessful termination of a HARQ process associated with the second transport block, wherein receiving the signaling is in response to a failure of the UE to successfully decode the second transport block, the control information scheduling the first transport block having the same HARQ identifier as the second transport block, or both.

Some aspects described herein relate to a UE for wireless communication. The UE may include a processing system that includes one or more processors and one or more memories coupled with the one or more processors. The processing system may be configured to cause the UE to receive, from a network node, control information scheduling a first transport block and indicating that the first transport block has a same HARQ identifier as a second transport block. The processing system may cause the UE to identify an unsuccessful termination of a HARQ process associated with the second transport block in response to a failure of the UE to successfully decode the second transport block, the control information scheduling the first transport block having the same HARQ identifier as the second transport block, or both. The processing system may cause the UE to transmit, to the network node, signaling indicating the unsuccessful termination of the HARQ process associated with the second transport block.

Some aspects described herein relate to a network node for wireless communication. The network node may include a processing system that includes one or more processors and one or more memories coupled with the one or more processors. The processing system may cause the network node to transmit, to a UE, control information scheduling a first transport block and indicating that the first transport block has a same HARQ identifier as a second transport block. The processing system may cause the network node to receive, from the UE, signaling indicating an unsuccessful termination of a HARQ process associated with the second transport block, wherein receiving the signaling is in response to a failure of the UE to successfully decode the second transport block, the control information scheduling the first transport block having the same HARQ identifier as the second transport block, or both.

Some aspects described herein relate to a non-transitory computer-readable medium that stores a set of instructions for wireless communication by a UE. The set of instructions, when executed by one or more processors of the UE, may cause the UE to receive, from a network node, control information scheduling a first transport block and indicating that the first transport block has a same HARQ identifier as a second transport block. The set of instructions, when executed by one or more processors of the UE, may cause the UE to identify an unsuccessful termination of a HARQ process associated with the second transport block in response to a failure of the UE to successfully decode the second transport block, the control information scheduling the first transport block having the same HARQ identifier as the second transport block, or both. The set of instructions, when executed by one or more processors of the UE, may cause the UE to transmit, to the network node, signaling indicating the unsuccessful termination of the HARQ process associated with the second transport block.

Some aspects described herein relate to a non-transitory computer-readable medium that stores a set of instructions for wireless communication by a network node. The set of instructions, when executed by one or more processors of the network node, may cause the network node to transmit, to a UE, control information scheduling a first transport block and indicating that the first transport block has a same HARQ identifier as a second transport block. The set of instructions, when executed by one or more processors of the network node, may cause the network node to receive, from the UE, signaling indicating an unsuccessful termination of a HARQ process associated with the second transport block, wherein receiving the signaling is in response to a failure of the UE to successfully decode the second transport block, the control information scheduling the first transport block having the same HARQ identifier as the second transport block, or both.

Some aspects described herein relate to an apparatus for wireless communication. The apparatus may include means for receiving, from a network node, control information scheduling a first transport block and indicating that the first transport block has a same HARQ identifier as a second transport block. The apparatus may include means for identifying an unsuccessful termination of a HARQ process associated with the second transport block in response to a failure of the UE to successfully decode the second transport block, the control information scheduling the first transport block having the same HARQ identifier as the second transport block, or both. The apparatus may include means for transmitting, to the network node, signaling indicating the unsuccessful termination of the HARQ process associated with the second transport block.

Some aspects described herein relate to an apparatus for wireless communication. The apparatus may include means for transmitting, to a UE, control information scheduling a first transport block and indicating that the first transport block has a same HARQ identifier as a second transport block. The apparatus may include means for receiving, from the UE, signaling indicating an unsuccessful termination of a HARQ process associated with the second transport block, wherein receiving the signaling is in response to a failure of the UE to successfully decode the second transport block, the control information scheduling the first transport block having the same HARQ identifier as the second transport block, or both.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network in accordance with the present disclosure.

FIG. 2 is a diagram illustrating an example network node in communication with an example UE in a wireless network in accordance with the present disclosure.

FIG. 3 is a diagram illustrating an example disaggregated base station architecture in accordance with the present disclosure.

FIG. 4 is a diagram illustrating an example associated with identifying unsuccessful terminations of HARQ processes in accordance with the present disclosure.

FIG. 5 is a diagram illustrating a wireless communication network in accordance with the present disclosure.

FIGS. 6A through 9B are diagrams illustrating examples of signaling exchanged between a transmitting and receiving device in accordance with the present disclosure.

FIG. 10 is a diagram illustrating an example of signaling exchanged between a network node and a UE in accordance with the present disclosure.

FIGS. 11 and 12 are flowcharts illustrating example processes performed in accordance with the present disclosure.

FIGS. 13 and 14 are diagrams of example apparatuses for wireless communication that support identifying unsuccessful terminations of HARQ processes in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

In some wireless communication networks, devices (for example, a user equipment (UE), a network node) may perform a hybrid automatic repeat request (HARQ) process to improve a reliability of communications exchanged between the devices. For example, a transmitting device may send a transport block (for example, data) to a receiving device, and the receiving device may attempt to decode the data. In cases where the receiving device successfully decodes the data, the receiving device may transmit a HARQ acknowledgement (ACK) message to the transmitting device. Additionally, in cases where the receiving device fails to successful decode the data, the receiving device may transmit a HARQ negative ACK (NACK) message to the transmitting device. In response to receiving a HARQ NACK message from the receiving device, the transmitting device may perform a retransmission associated with the transport block. For example, the transmitting device may retransmit a portion of the transport block (for example, corresponding to the portion of the transport block that the receiving device was unable to successfully decode). Additionally or alternatively, the transmitting device may retransmit the transport block using a same or different redundancy version (for example, using the same or different set of coded bits associated with the transport block), which may allow for the receiving device to perform soft combining or incremental redundancy combining. Upon receiving the retransmission from the transmitting device, the receiving device may attempt to decode the transport block using a combination of the data received in the initial transmission of the transport block and the data received in the retransmission.

In some cases, the transmitting device may continue to send retransmissions associated with the transport block until the transmitting device receives a HARQ ACK message from the receiving device (for example, indicating that the receiving device successfully decoded the transport block). In response to receiving the HARQ ACK message from the receiving device, the transmitting device may terminate the HARQ process. To terminate the HARQ process, the transmitting device may discard data associated with the transport block (for example, from a buffer that is maintained prior to the termination of the HARQ process). In some other cases, the transmitting device may terminate the HARQ process without receiving a HARQ ACK message from the receiving device. For example, the transmitting device may terminate the HARQ process after a quantity of retransmissions performed by the transmitting device satisfies (for example, is equal to or greater than) a quantity threshold associated with a quantity of retransmissions.

In some wireless communication networks, the devices may additionally support certain radio link control (RLC) processes to improve a reliability of communications between devices. The RLC processes may correspond to processes and communications performed at an RLC layer of the devices. In some cases, the receiving device may detect “holes” (for example, may detect one or more RLC SDU segments that the receiving device has failed to decode). For example, the receiving device may detect holes based on a sequence number associated with the RLC SDU segments, segmentation information associated with the RLC SDU segments, and/or a segment offset associated with the RLC SDU segments.

In response to detecting or failing to detect holes associated with the RLC, the receiving device may transmit an RLC NACK or RLC ACK, respectively. In some cases, the receiving device transmitting an RLC NACK may trigger the transmitting device to retransmit one or more segments of the RLC SDU. Additionally, the receiving device transmitting an RLC ACK may trigger the transmitting device to release a buffer (for example, an upper layer buffer) associated with the RLC SDU.

A receiving device may detect holes as part of an RLC process when the RLC is operating in accordance with the acknowledgement mode in instances where the transmitting device terminates the HARQ process without receiving a HARQ ACK from the receiving device (for example, due to a channel condition between the transmitting and receiving devices, due to a quantity of retransmissions of the transport block performed as part of the HARQ process satisfying a threshold). In this example, the lower layer of the transmitting device (for example, the PHY layer) may report the termination of the HARQ process to an upper layer of the transmitting device (for example, the RLC layer). Here, the transmitting device may be triggered to retransmit the one or more segments of the RLC SDU in response to receiving the indication of the termination of the HARQ process from the lower layer.

In another example, the receiving device may detect holes as part of an RLC process when the RLC is operating in accordance with the acknowledgement mode as a result of a premature ARQ process initiation. Here, the receiving device may transmit an RLC NACK to the transmitting device in cases where the HARQ process has not been terminated (for example, in an RLC status report), and may eventually decode the transport block via the HARQ process. Additionally, the receiving device may detect holes as part of the RLC process in instances of a NACK to ACK error. For example, if the receiving device transmits a HARQ NACK to the transmitting device and the transmitting device interprets the HARQ NACK as a HARQ ACK, the transmitting device may terminate the HARQ process (for example, may stop transmissions and/or retransmissions for a transport block).

In some cases, a receiving device (for example, a UE) may detect NACK to ACK errors based on hole detection and a timer. That is, the UE may be configured to transmit an RLC status report indicating RLC NACKs upon an expiration of the timer. The expiration time of the timer may be configured with a value to decrease a latency associated with the UE detecting and reporting NACK to ACK errors while also avoiding instances where the UE initiates a premature ARQ process (for example, when the UE transmits an RLC NACK associated with a transport block and subsequently decodes the transport block as part of a HARQ process). In some cases, increasing an amount of time prior to the expiration of the timer may decrease a likelihood that the UE initiates the premature ARQ process, but may in turn increase a latency associated with the UE detecting the NACK to ACK errors.

Various aspects relate generally to a receiving device (for example, a UE) detecting NACK to ACK errors prior to an expiration of the timer associated with the UE indicating RLC NACKs. Some aspects more specifically relate to the UE detecting an unsuccessful termination of a HARQ process (for example, due to a NACK to ACK error) associated with a transport block prior to the expiration of the timer, and reporting the unsuccessful termination of the HARQ process associated with the transport block to a transmitting device (for example, a network node). For example, the UE May detect and report instances where a transport block associated with a HARQ process identifier is not decoded and the UE receives another transport block associated with the same HARQ process identifier. Additionally, the UE may detect and report instances where a transport block associated with a HARQ identifier is associated with a new data indicator (NDI) value that is different from an expected value (for example, which may correspond to instances where the UE previously failed to receive or decode control information scheduling another transport block associated with the same HARQ identifier and the other transport block). In both instances, the UE detecting and reporting the unsuccessful termination of the HARQ process based on the HARQ identifiers associated with the transport blocks, a failure of the UE to successfully decode the transport block, and/or a value of the NDI may enable the UE to detect and report NACK to ACK errors prior to the expiration of the timer. Then, the network node may initiate an ARQ process (for example, in response to receiving the report from the UE that indicates the unsuccessful termination of the HARQ process) prior to the expiration of the timer.

Particular aspects of the subject matter described in this disclosure can be implemented to realize one or more of the following potential advantages. In some examples, the described techniques can be used to decrease a latency and signaling overhead associated with communications between devices. For example, the UE detecting and reporting NACK to ACK errors prior to the expiration of the timer may decrease the latency associated with initiating RLC retransmissions in instances of NACK to ACK errors without increasing signaling overhead (for example, due to increased instances of the UE initiating the ARQ process prematurely). Additionally, the described techniques can be used to decrease overhead at the UE by decreasing buffering at the UE (or at another receiving device). For example, if a latency associated with receiving missing packets (for example, missing RLC SDUs, missing RCL SDU segments) is reduced by decreasing a delay associated with initiating ARQ processes, the UE can decrease a usage of a high-layer buffer (for example, a buffer at the RLC layer, a buffer at the PDCP layer) in cases when in-order delivery of packets is required (for example, such as when the RLC is operating in accordance with the acknowledgement mode).

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

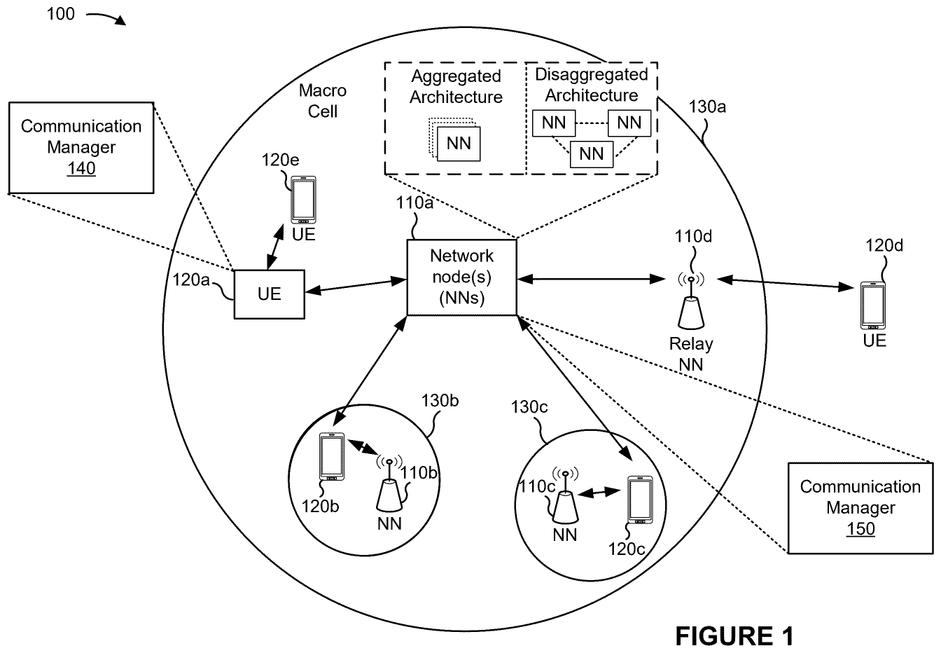

FIG. 1 is a diagram illustrating an example of a wireless communication network 100 in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120c.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHZ), FR2 (24.25 GHz through 52.6 GHZ), FR3 (7.125 GHz through 24.25 GHZ), FR4a or FR4-1 (52.6 GHz through 71 GHZ), FR4 (52.6 GHZ through 114.25 GHZ), and FR5 (114.25 GHz through 300 GHz). Although a portion of FR1 is greater than 6 GHZ, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GH2), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHZ, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/LTE and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node May have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUs). A CU may host one or more higher layer control functions, such as radio resource control (RRC) functions, PDCP functions, and/or service data adaptation protocol (SDAP) functions, among other examples. A DU may host one or more of an RLC layer, a MAC layer, and/or one or more higher PHY layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, in accordance with a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move in accordance with the location of an associated mobile network node 110 (for example, a train, a satellite base station, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In such examples, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”. An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified in accordance with different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, enhanced mobile broadband (eMBB), and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or cMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120c) may communicate directly with one another using sidelink communications (for example, without communicating by way of a network node 110 as an intermediary). As an example, the UE 120a may directly transmit data, control information, or other signaling as a sidelink communication to the UE 120c. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, the UE 120 may include a communication manager 140. As described in more detail elsewhere herein, the communication manager 140 may receive, from a network node, control information scheduling a first transport block and indicating that the first transport block has a same HARQ identifier as a second transport block; identify an unsuccessful termination of a HARQ process associated with the second transport block in response to a failure of the UE to successfully decode the second transport block, the control information scheduling the first transport block having the same HARQ identifier as the second transport block, or both; and transmit, to the network node, signaling indicating the unsuccessful termination of the HARQ process associated with the second transport block. Additionally or alternatively, the communication manager 140 may perform one or more other operations described herein.

In some aspects, the network node 110 may include a communication manager 150. As described in more detail elsewhere herein, the communication manager 150 may transmit, to a UE, control information scheduling a first transport block and indicating that the first transport block has a same HARQ identifier as a second transport block; and receive, from the UE, signaling indicating an unsuccessful termination of a HARQ process associated with the second transport block, wherein receiving the signaling is in response to a failure of the UE to successfully decode the second transport block, the control information scheduling the first transport block having the same HARQ identifier as the second transport block, or both. Additionally or alternatively, the communication manager 150 may perform one or more other operations described herein.

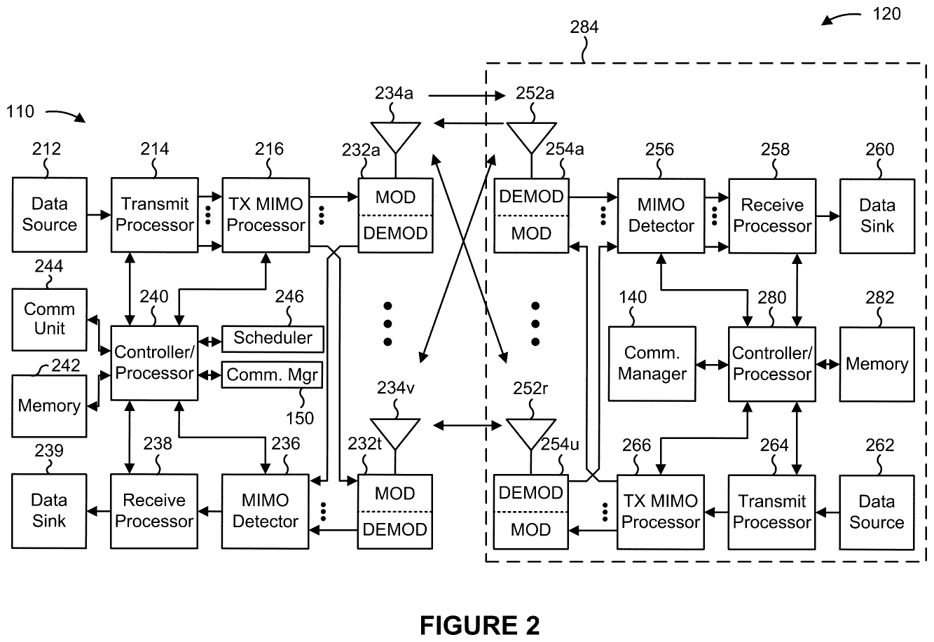

FIG. 2 is a diagram illustrating an example network node 110 in communication with an example UE 120 in a wireless network in accordance with the present disclosure.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more MCSs for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different quantities of antenna elements. For example, a UE 120 may include a single antenna element, two antenna elements, four antenna elements, eight antenna elements, or a different quantity of antenna elements. As another example, a network node 110 may include eight antenna elements, 24 antenna elements, 64 antenna elements, 128 antenna elements, or a different quantity of antenna elements. Generally, a larger quantity of antenna elements may provide increased control over parameters for beam generation relative to a smaller quantity of antenna elements, whereas a smaller quantity of antenna elements may be less complex to implement and may use less power than a larger quantity of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

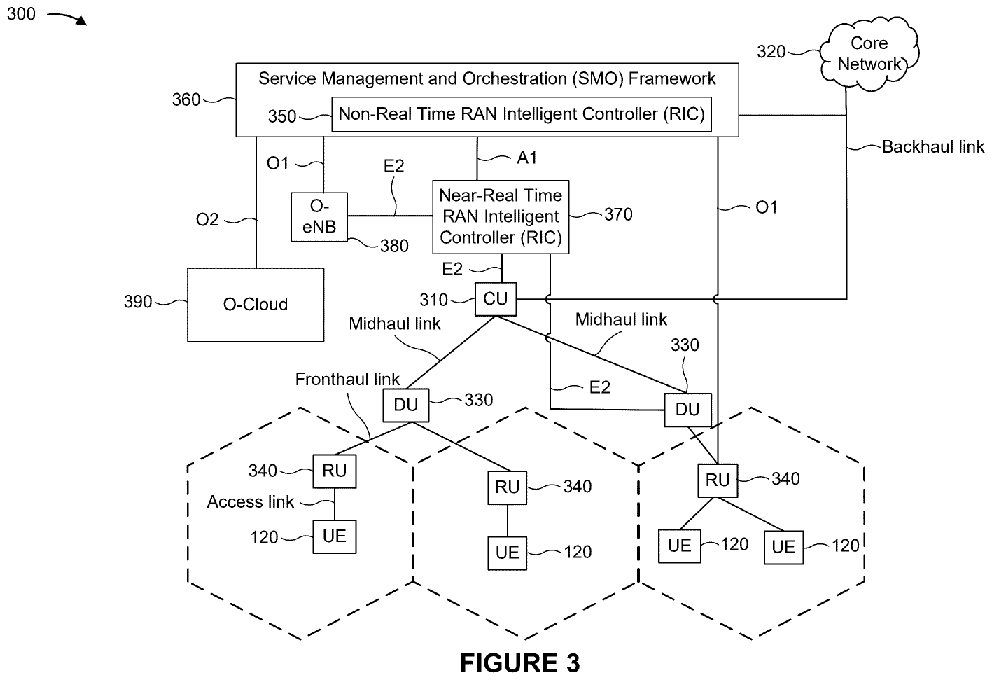

FIG. 3 is a diagram illustrating an example disaggregated base station architecture 300 in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUS 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-cNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

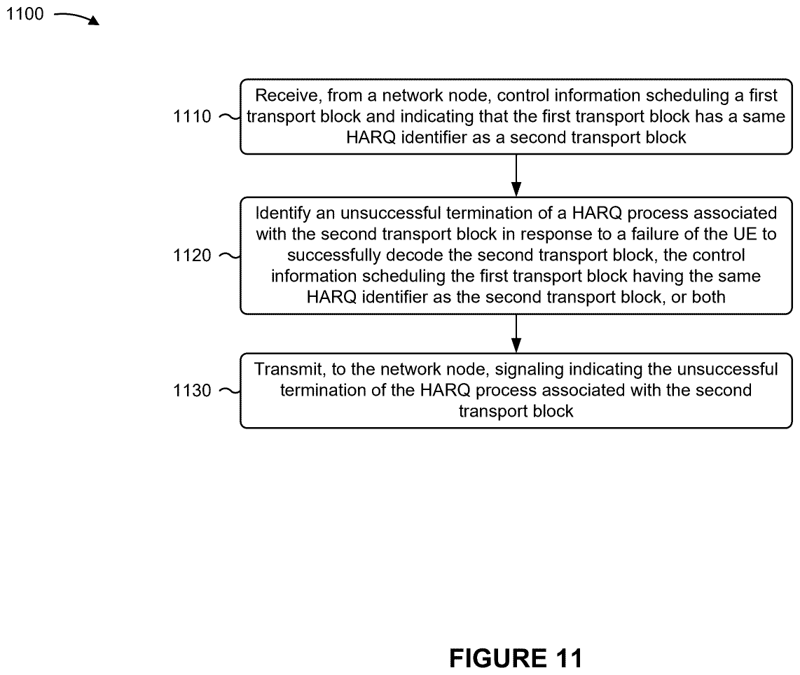

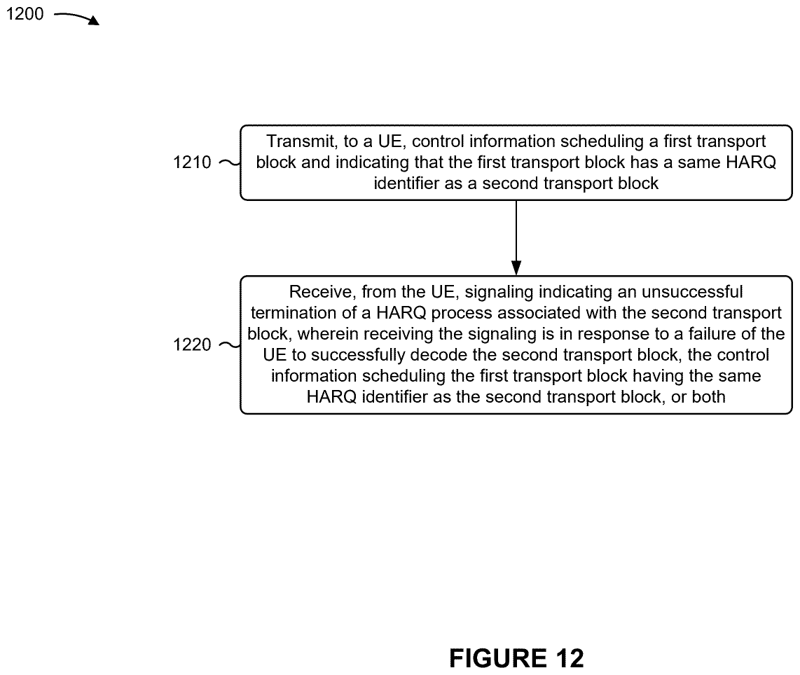

The network node 110, the controller/processor 240 of the network node 110, the UE 120, the controller/processor 280 of the UE 120, the CU 310, the DU 330, the RU 340, or any other component(s) of FIG. 1, 2, or 3 may implement one or more techniques or perform one or more operations associated with identifying unsuccessful terminations of HARQ processes, as described in more detail elsewhere herein. For example, the controller/processor 240 of the network node 110, the controller/processor 280 of the UE 120, any other component(s) of FIG. 2, the CU 310, the DU 330, or the RU 340 may perform or direct operations of, for example, process 1100 of FIG. 1, process 1200 of FIG. 12, or other processes as described herein (alone or in conjunction with one or more other processors). The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 1100 of FIG. 11, process 1200 of FIG. 12, or other processes as described herein. In some examples, executing instructions may include running the instructions, converting the instructions, compiling the instructions, and/or interpreting the instructions, among other examples.

In some aspects, the UE 120 includes means for receiving, from a network node, control information scheduling a first transport block and indicating that the first transport block has a same HARQ identifier as a second transport block; means for identifying an unsuccessful termination of a HARQ process associated with the second transport block in response to a failure of the UE to successfully decode the second transport block, the control information scheduling the first transport block having the same HARQ identifier as the second transport block, or both; and/or means for transmitting, to the network node, signaling indicating the unsuccessful termination of the HARQ process associated with the second transport block. The means for the UE 120 to perform operations described herein may include, for example, one or more of communication manager 140, antenna 252, modems 254, MIMO detector 256, receive processor 258, transmit processor 264, TX MIMO processor 266, controller/processor 280, or memory 282.

In some aspects, the network node 110 includes means for transmitting, to a UE, control information scheduling a first transport block and indicating that the first transport block has a same HARQ identifier as a second transport block; and/or means for receiving, from the UE, signaling indicating an unsuccessful termination of a HARQ process associated with the second transport block, wherein receiving the signaling is in response to a failure of the UE to successfully decode the second transport block, the control information scheduling the first transport block having the same HARQ identifier as the second transport block, or both. The means for the network node 110 to perform operations described herein may include, for example, one or more of communication manager 150, transmit processor 214, TX MIMO processor 216, the set of modems 232, antenna 234, MIMO detector 236, receive processor 238, controller/processor 240, memory 242, or scheduler 246.

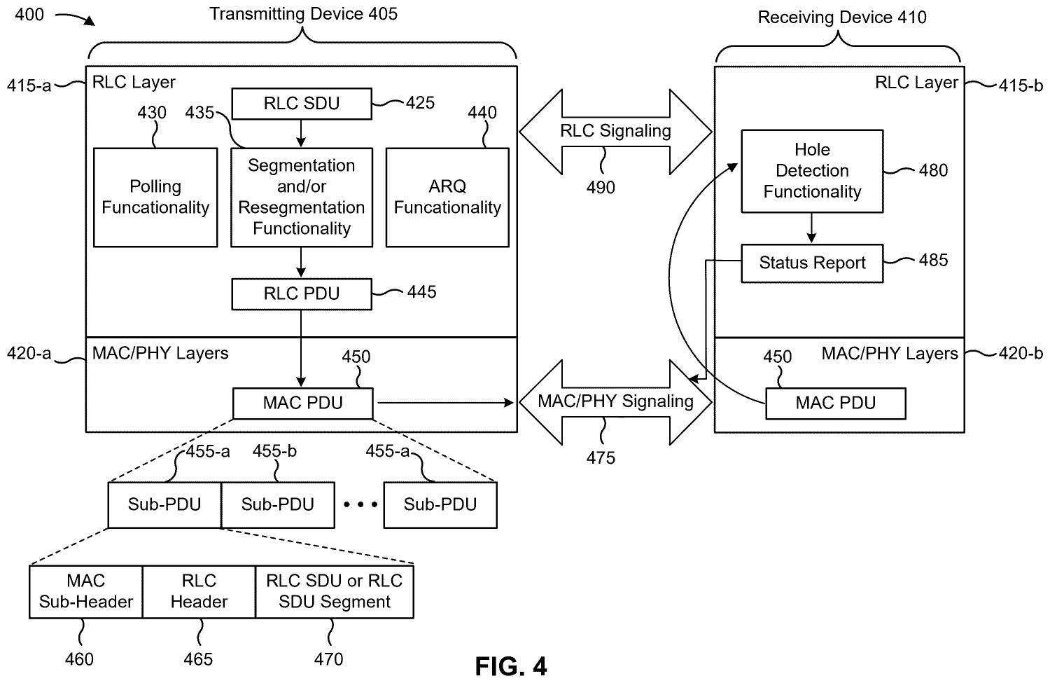

FIG. 4 is a diagram illustrating an example 400 associated with identifying unsuccessful terminations of HARQ processes, in accordance with the present disclosure. As shown in FIG. 4, a transmitting device 405 and a receiving device 410 may communicate with one another. For example, the transmitting device 405 may transmit, to the receiving device 410, the MAC PDU 450.

In some cases, the transmitting device 405 may correspond to a network node 110, the receiving device 410 may correspond to a UE 120, and the transmitting device 405 may transmit communications to the receiving device 410 via a downlink. In some other cases, the transmitting device 405 may correspond to a UE 120, the receiving device 410 may correspond to a network node 110, and the transmitting device 405 may transmit communications to the receiving device 410 via an uplink.

Both the transmitting device 405 and the receiving device 410 may include an RLC layer 415 and MAC/PHY layers 420 (for example, including a MAC layer, a PHY layer, or both a MAC layer and a PHY layer). Although not illustrated, the transmitting device 405 and the receiving device 410 may also include additional layers, such as PDCP layers, RRC layers, and/or SDAP layers. In the example 400, the RLC 415-a of the transmitting device 405 and the RLC layer 415-b of the receiving device 410 may exchange RLC signaling 490. Additionally, the MAC/PHY layers 420-a of the transmitting device 405 and the MAC/PHY layers 420-b of the receiving device 410 may exchange MAC/PHY signaling 475.

In the example 400, the RLC layer 415-a of the transmitting device 405 may receive the RLC SDU 425 from a PDCP layer of the transmitting device 405. The RLC layers 415 (for example, 415-a and 415-b) may have multiple different modes. In particular, the transmitting device 405 and the receiving device 410 may operate the RLC layers 415 in accordance with a transparent mode, an unacknowledged mode, or an acknowledged mode. In an example where the RLC layer 415-a is operating in accordance with the transparent mode, the receiving device 410 may pass the RLC SDU 425 through the RLC layer 415-a (for example, from the PDCP layer to the MAC layer of the transmitting device 405) as an RLC PDU 445 without additional processing by the RLC layer 415-a. In another example where the RLC layer 415-a is operating in accordance with the unacknowledged mode, the transmitting device 405 may perform segmentation functionality (for example, of the segmentation and/or resegmentation functionality 435 illustrated in example 400), but may not perform the ARQ functionality 440. In another example where the RLC layer 415-a is operating in accordance with the acknowledged mode, the transmitting device 405 may perform the segmentation and/or resegmentation functionality 435 and the ARQ functionality 440.

When operating the RLC layer 415-a in accordance with the acknowledgement mode, the transmitting device 405 may perform the segmentation and/or resegmentation functionality 435 to fit the RLC SDU 425 into available resources (for example, for transmission). For example, the transmitting device 405 may segment the RLC SDU 425 to generate multiple RLC SDU segments. The transmitting device 405 may perform re-segmentation functionalities (for example, of the segmentation and/or resegmentation functionality 435) to support the ARQ functionality 440, where an available payload size may change.

The RLC layer 415-a of the transmitting device 405 may generate the RLC PDU 445, which may include the RLC SDU 425. In some cases, the RLC PDU 445 may include one or multiple RLC SDUs 425 or one or multiple RLC SDU segments (for example, generated by the segmentation functionality of the segmentation and/or resegmentation functionality 435) associated with the RLC SDU 425. Each RLC SDU segment in the RLC PDU 445 may include a header that includes a sequence number associated with the RLC SDU segment. Then, the RLC layer 415-a may provide the RLC PDU 445 to the MAC/PHY layers 420-a of the transmitting device, and the MAC/PHY layers 420-a may receive the MAC PDU 450.

The MAC PDU 450 may correspond to a transport block (for example, transmitted from the transmitting device 405 to the receiving device via the MAC/PHY signaling 475). The MAC PDU 450 may include one or multiple sub-PDUs 455 (for example, MAC SDUs). Each sub-PDU 455 may include a MAC sub-header 460, an RLC header 465, and an RLC SDU or RLC SDU segment 470. In some examples, the RLC PDU 445 may correspond to the RLC header 465 and the RLC SDU or RLC SDU segment 470 in each sub-PDU 455. The RLC header 465 may include information related to the RLC SDU or RLC SDU segment 470. For example, the RLC header 465 may include a sequence number associated with the RLC SDU or RLC SDU segment 470, segmentation information associated with an RLC SDU segment of the RLC SDU or RLC SDU segments 470, and/or a segment offset associated with an RLC SDU segment of the RLC SDU or RLC SDU segments 470.

The MAC/PHY layers 420-a of the transmitting device 405 may transmit, via the MAC/PHY signaling 475, the MAC PDU 450 to the receiving device 410. The MAC/PHY layers 420-b of the receiving device 410 may provide the MAC PDU 450 to the RLC layer 415-b of the receiving device 410. The receiving device 410 may perform a HARQ process associated with the MAC PDU 450. For example, in cases where the receiving device 410 successfully decodes the MAC PDU 450, the receiving device 410 may transmit a HARQ ACK message to the transmitting device 405 via the MAC/PHY signaling 475. Additionally, in cases where the receiving device 410 fails to successful decode the MAC PDU 450, the receiving device 410 may transmit a HARQ NACK message to the transmitting device 405 via the MAC/PHY signaling 475. In response to receiving a HARQ NACK message from the receiving device 410, the transmitting device 405 may perform a retransmission associated with the MAC PDU 450. For example, the transmitting device 405 may retransmit a portion of the MAC PDU 450 (for example, that is selected based on the portion of the MAC PDU 450 that the receiving device 410 was unable to successfully decode). Upon receiving the retransmission from the transmitting device 405, the receiving device 410 may attempt to decode the MAC PDU 450 using a combination of the data received in the initial transmission of the transport block and the data received in the retransmission.

In some cases, the transmitting device 405 may continue to send retransmissions associated with the MAC PDU 450 until the transmitting device 405 receives a HARQ ACK message from the receiving device 410 (for example, indicating that the receiving device successfully decodes the MAC PDU 450). In response to receiving the HARQ ACK message from the receiving device 410, the transmitting device 405 may terminate the HARQ process. In some other cases, the transmitting device 405 may terminate the HARQ process without receiving a HARQ ACK message from the receiving device 410. For example, the transmitting device 405 may terminate the HARQ process after a quantity of retransmissions performed by the transmitting device 405 satisfies (for example, is equal to or greater than) a quantity threshold associated with a quantity of retransmissions.

In cases where the RLC layer 415-b of the receiving device is operating in accordance with the acknowledgement mode, the receiving device 410 may additionally perform an ARQ process. For example, the RLC layer 415-b of the receiving device 410 may support the ARQ functionality 440. Here, the RLC layer 415-b of the receiving device 410 may have a hole detection functionality 480, which may enable the receiving device 410 to detect holes (for example, to detect one or more RLC SDU segments 470 in a MAC PDU 450 that the receiving device 410 has failed to decode). In some cases, the receiving device 410 may detect holes based on a sequence number associated with the RLC SDU or RLC SDU segments 470 (for example, included in the RLC header 465), segmentation information associated with the RLC SDU or RLC SDU segments 470 (for example, included in the RLC header 465, included in the MAC sub-header 460), and/or a segment offset associated with the RLC SDU or RLC SDU segments 470 (for example, included in the RLC header 465, included in the MAC sub-header 460). In some instances, the receiving device 410 may detect the holes with or without assistance from a lower layer (for example, MAC/PHY layers 420-b of the receiving device 410).

The receiving device 410 may detect holes associated with a transmission of the MAC PDU 450 based on a timer (for example, a t-Reassembly timer). For example, the receiving device 410 may identify one or more missing RLC SDUs or RLC SDU segments 470 based on the sequence numbers associated with RLC SDUs or RLC SDU segments 470 that have been successfully received and decoded. The receiving device 410 may initiate the timer in response to identifying that one or more RLC SDUs or RLC SDU segments 470 are missing. If, prior to an expiration of the timer, the receiving device 410 does successfully receive and decode the one or more missing RLC SDUs or RLC SDU segments 470 (for example, as part of a HARQ process associated with the MAC PDU 450), the receiving device 410 may reset the timer. Additionally, if the receiving device 410 does not successfully receive and decode the one or more missing RLC SDUs or RLC SDU segments 470 prior to the expiration of the timer, the receiving device 410 may generate and transmit the status report 485 to the transmitting device 405.

In one example, the receiving device may detect holes as part of the RLC process in instances of a HARQ NACK to HARQ ACK error. In this example, the receiving device 410 may transmit a HARQ NACK to the transmitting device 405, and the transmitting device 405 may interpret the HARQ NACK as a HARQ ACK. As a result, the transmitting device 405 may terminate the HARQ process (for example, may stop HARQ transmissions and/or retransmissions for the MAC PDU 450).

In the example 400, the receiving device 410 may detect NACK to ACK errors prior to an expiration of the timer associated with the hole detection functionality 480 (for example, prior to the expiration of the t-Reassembly timer). In particular, the receiving device 410 may detect the NACK to ACK errors based on detecting an unsuccessful termination of a HARQ process (for example, due to a NACK to ACK error) associated with the MAC PDU 450. Then, the receiving device 410 may report the unsuccessful termination of the HARQ process associated with the MAC PDU 450 to the transmitting device 405. For example, the receiving device 410 may detect and report instances where a MAC PDU 450 associated with a HARQ process identifier is not decoded and the receiving device 410 receives another MAC PDU 450 associated with the same HARQ process identifier. Additionally, the receiving device 410 may detect and report instances where a MAC PDU 450 associated with a HARQ identifier is associated with an NDI value that is different from an expected value (for example, which may correspond to instances where the receiving device 410 previously failed to receive or decode control information scheduling another MAC PDU 450 associated with the same HARQ identifier and the other MAC PDU 450).

The status report 485 may be associated with a timer (for example, a t-StatusProhibit timer). Here, the receiving device 410 may refrain from transmitting the status report 485 until the timer expires. In some cases, the receiving device 410 waiting until the timer expires to transmit the status report 485 may decrease a periodicity associated with the receiving device 410 sending status reports 485. That is, after the receiving device 410 sends a status report 485, the receiving device 410 may reset and start (for example, initiate) the timer and may be unable to send another status report 485 until an expiration of the timer. The status report 485 may include RLC ACK and/or RLC NACK for certain sequence numbers (for example, associated with the MAC PDU 450).

The receiving device 410 may transmit a status report 485 in response to a polling request from the transmitting device 405. For example, the transmitting device 405 may include the polling functionality 430 at the RLC layer 415-a. In this example, the transmitting device may transmit, to the receiving device 410 (for example, via the RLC signaling 490, via the MAC/PHY signaling 475) a polling request triggering the receiving device 410 to transmit the status report 485 to the transmitting device 405. The transmitting device 405 may transmit the polling request based on a quantity of MAC PDUs 450 transmitted to the receiving device 410. For example, the transmitting device 405 may transmit the polling request after transmitting a certain quantity of MAC PDUs 450 (for example, as indicated by a variable such as a pollPDU variable). In another case, the transmitting device 405 may transmit the polling request based on a quantity of bytes transmitted (for example, via one or more MAC PDUs 450) to the receiving device 410. For example, the transmitting device 405 may transmit the polling request after transmitting a certain quantity of bytes (for example, as indicated by a variable such as a pollByte variable).

The receiving device 410 may transmit the status report 485 via the MAC/PHY signaling 475 or, in some other cases, via the RLC signaling 490. In response to receiving the status report 485, the transmitting device 405 may perform an ARQ process (for example, using the ARQ functionality 440 of the RLC layer 415-a). For example, the transmitting device 405 may retransmit any of the RLC SDU or RLC SDU segments 470 that correspond to a sequence number indicated as not successfully received and decoded in the status report 485. In some cases, the transmitting device 405 may continue transmitting retransmissions of any RLC SDUs or RLC SDU segments 470 until the receiving device 410 indicates that the RLC SDUs or RLC SDU segments 470 have been successfully received and decoded (for example, via an RLC ACK for the sequence numbers associated with the RL SDUs or RLC SDU segments 470). Additionally or alternatively, the transmitting device 405 may refrain from transmitting a retransmission of an RLC SDU or RLC SDU segment 470 in instances where a quantity of retransmissions associated with that RLC SDU or RLC SDU segment 470 is greater than a threshold (for example, a maxRetxThreshold).

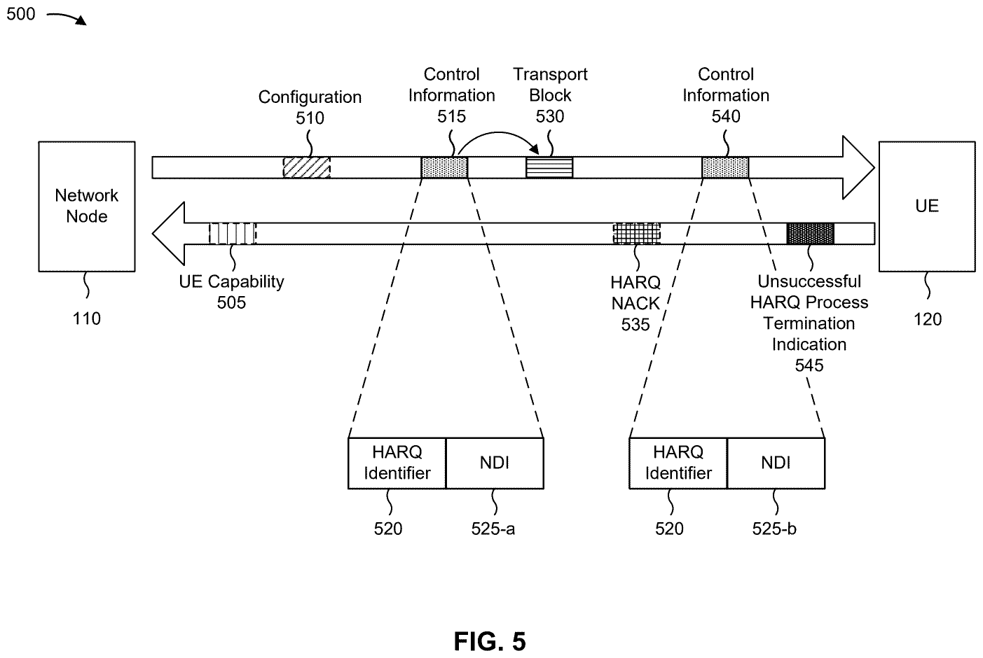

FIG. 5 is a diagram illustrating a wireless communication network 500, in accordance with the present disclosure. As shown in FIG. 5, a network node 110 and a UE 120 may communicate with one another. In some cases, the UE 120 may be configured to detect and report unsuccessful terminations of HARQ processes, as described herein. For example, the UE 120 may transmit, to the network node 110, an unsuccessful HARQ process termination indication 545 in instances where the UE 120 identifies an unsuccessful termination of a HARQ process associated with transport block 530. In some cases, the transport block 530 may include aspects of the MAC PDU 450.

The UE 120 may optionally indicate, to the network node 110, the UE capability 505 of the UE 120 to support the detecting and reporting of unsuccessful HARQ process terminations.

The network node 110 may transmit, and the UE 120 may receive, the configuration 510. In particular, the network node 110 may transmit signaling to the UE 120 that indicates for the UE 120 to report unsuccessful terminations of HARQ processes to the network node 110. In cases where the UE 120 transmits the UE capability 505, the network node 110 may transmit the configuration 510 to the UE 120 in response to the UE 120 indicating, via the UE capability 505, that the UE 120 is capable of supporting the reporting of unsuccessful terminations of HARQ processes.

The configuration 510 may indicate a configuration for the UE to report unsuccessful HARQ process terminations on a per cell-group basis. For example, the configuration 510 may indicate for the UE 120 to report unsuccessful HARQ process terminations for each component carrier in the cell group and for each HARQ identifier associated with each component carrier. In another case, the configuration 510 may indicate for the UE 120 to report unsuccessful HARQ process terminations on a per component carrier basis. For example, the configuration 510 may indicate for the UE 120 to report unsuccessful HARQ process terminations for each HARQ identifier associated with one or more component carriers and for the UE 120 to refrain from reporting unsuccessful HARQ process terminations for HARQ identifiers associated with one or more other component carriers.

In another case, the configuration 510 may indicate for the UE 120 to report unsuccessful HARQ process terminations on a per subset of HARQ identifiers basis (for example, for subsets of HARQ identifiers that are associated with a component carrier). Here, the network node 110 may configure (for example, via the configuration 510 or via other configuration signaling) the subset of HARQ identifiers. For example, the network node 110 may indicate a list of HARQ identifiers, per component carrier, for which the UE 120 is configured to report unsuccessful HARQ process terminations. Additionally or alternatively, the network node 110 may enable or disable the reporting of unsuccessful HARQ process terminations per HARQ identifier and per component carrier. In one example, the network node 110 may use a first subset of HARQ identifiers in a component carrier (for example, HARQ identifiers 0-7) for delay sensitive traffic (for example, for communications associated with extended reality (XR)). Here, the network node 110 may indicate, via the configuration 510, for the UE 120 to report unsuccessful HARQ process terminations associated with the first subset of HARQ identifiers in the component carrier and for the UE 120 to refrain from reporting unsuccessful HARQ process terminations for a second subset of HARQ identifiers in the component carrier or for the HARQ identifiers associated with other component carriers.

The network node 110 may transmit the configuration 510 via RRC signaling, a MAC-CE, or DCI. In one example where the network node 110 transmits the configuration 510 to the UE 120 via the DCI, the configuration 510 and the control information 515 may be carried by a same DCI message. That is, the DCI may carry both the configuration 510 and the control information 515 scheduling the transport block 530. In this example, the network node 110 may dynamically enable or disable (for example, via the DCI signaling) UE reporting of unsuccessful HARQ process terminations for HARQ processes associated with a given HARQ identifier.

The network node 110 may transmit, and the UE 120 may attempt to receive and decode, the control information 515. In some cases, the control information 515 may be transmitted via DCI signaling. The control information 515 may schedule a transmission of the transport block 530. That is, the control information 515 may include scheduling information for one or more PDSCH transmissions (for example, for one or more transport blocks 530 transmitted via a PDSCH). In particular, the control information 515 may indicate a set of resources (for example, one or more time domain resources, one or more frequency domain resources) for the UE 120 to monitor in order to detect the subsequent transmission of the transport block 530. The control information 515 may also include an indication of a HARQ identifier 520 and an NDI 525-a associated with the transport block 530 being scheduled.

The network node 110 may transmit, and the UE 120 may attempt to receive and decode, the transport block 530 (for example, via a PDSCH and in accordance with the control information 515). In some cases, the UE 120 may be unable to decode at least a portion of the transport block 530. In one example, the UE 120 may successfully receive and decode the control information 515 and, in accordance with the control information 515, may monitor a set of resources associated with the transport block 530. After monitoring the set of resources, the UE 120 may be unable to successfully decode the transport block 530. Here, the UE 120 may transmit a HARQ NACK 535 to the network node 110. In another example, the UE 120 may not successfully receive and decode the control information 515. In this example, the UE 120 may not monitor resources associated with the transport block 530 and, as a result, may not receive or decode the transport block 530. Here, the UE 120 may not transmit the HARQ NACK 535 to the network node 110. In some cases, the UE 120 not transmitting any HARQ messages associated with the transport block 530 (for example, the UE 120 does not transmit a HARQ ACK or a HARQ NACK) may indicate to the network node 110 a failure of the UE to successfully decode the transport block 530 (for example, may indicate an equivalent of the HARQ NACK 535).

In the example 500, the network node 110 may incorrectly interpret the HARQ NACK 535 or the failure of the UE 120 to transmit any HARQ feedback associated with the transport block 530 as a HARQ ACK. That is, the network node 110 may determine, incorrectly, that the UE 120 successfully decoded the transport block 530 in cases where the UE 120 did not successfully decode the transport block 530. This may be referred to as a NACK to ACK error. As a result of the NACK to ACK error, the network node 110 may terminate a HARQ process associated with the transport block 530 (for example, and associated with the HARQ identifier 520) and may not transmit any future retransmissions associated with the transport block 530 as part of the HARQ process.

After the NACK to ACK error associated with the HARQ identifier 520, the network node 110 may transmit additional control information 540 scheduling another transport block associated with the same HARQ identifier 520 as the transport block 530 (which the UE 120 failed to successfully decode). The control information 540 may include information indicating a set of resources associated with a subsequent PDSCH transmission (for example, the other transport block), an indication that the other transport block is associated with the same HARQ identifier 520 as the transport block 530, and an NDI 525-b associated with the other transport block. In some cases, the NDI 525-b may be different from the NDI 525-a. For example, the NDI 525-a may be set to 0, while the NDI 525-b is toggled to 1, which may indicate that the control information 540 is associated with a different transport block than the transport block 530. That is, in instances where the NDI 525-b is different from the NDI 525-a, the UE 120 may determine that the control information 540 is scheduling a new transport block. Additionally or alternatively, the NDI 525-b being the same as the NDI 525-a indicates that the control information 540 may be associated with the transport block 530. For example, if the NDI 525-b is the same as the NDI 525-a, the UE 120 may determine that the control information 540 is scheduling a retransmission of the transport block 530.

The UE 120 may identify an unsuccessful HARQ process termination associated with the HARQ identifier 520. For example, the UE 120 may detect the unsuccessful HARQ process termination in response to receiving the control information 540 scheduling a new transport block associated with the same HARQ identifier 520 while the UE 120 has not successfully decoded a previously-transmitted transport block 530. In particular, if the UE 120 receives, while the UE 120 has not successfully decoded the transport block 530, the control information 540 scheduling the other transport block associated with the same HARQ identifier as the transport block 530 and having an NDI 525-b that is different from the NDI 525-a, the UE 120 may identify the unsuccessful termination of the HARQ process associated with the transport block 530 and the HARQ identifier 520.

In response to identifying the unsuccessful termination of the HARQ process and in accordance with the configuration 510, the UE 120 may transmit an unsuccessful HARQ process termination indication 545 to the network node 110. The UE 120 may transmit the unsuccessful HARQ process termination indication 545 via UCI on a PUCCH or a PUSCH. If the UE 120 transmits the unsuccessful HARQ process termination indication 545 via UCI, the network node 110 may reserve periodic resources (for example, periodic PUCCH resources, periodic CG-PUSCH resources) for the UE 120 to use for the transmission of the unsuccessful HARQ process termination indication 545. Additionally or alternatively, the UE 120 may transmit a scheduling request to the network node 110 that may, for example, indicate that the UE 120 identified the unsuccessful termination of the HARQ process and/or may indicate that the UE 120 is requesting to transmit the unsuccessful HARQ process termination indication 545. In response to receiving the scheduling request, the network node 110 may dynamically schedule a PUCCH or PUSCH transmission by the UE 120 for the unsuccessful HARQ process termination indication 545. In some cases where the UE 120 transmits the unsuccessful HARQ process termination indication 545 via UCI, the UE 120 may not include time stamp information related to the unsuccessful HARQ process termination.

In another case, the UE 120 may transmit the unsuccessful HARQ process termination indication 545 via a MAC-CE on a PUSCH. Here, the MAC-CE may have a fixed length or a variable length. Additionally, the MAC-CE that carries the unsuccessful HARQ process termination indication 545 may include a specific logical channel identifier (LCID).

In another case, the UE 120 may transmit the unsuccessful HARQ process termination indication 545 via an RLC status report on a PUSCH. In some cases, the RLC status report may include aspects of the status report 485 described with reference to FIG. 4. For example, the UE 120 may transmit the unsuccessful HARQ process termination indication 545 via the RLC status report by reporting an RLC NACK for RLC SDUs or SDU segments that are associated with the transport block 530 (for example, based on missing sequence numbers). Here, the UE 120 may transmit the RLC status report prior to an expiration of a timer associated with status report transmissions (for example, prior to an expiration of the t-StatusProhibit timer) in response to identifying the unsuccessful termination of the HARQ process.

If the UE 120 transmits the unsuccessful HARQ process termination indication 545 via the RLC status report, the UE 120 may refrain from transmitting an RLC status report including RLC NACKs associated with the transport block 530, or the UE 120 may additionally transmit the RLC status report including RLC NACKs associated with the transport block 530. That is, in either case, the UE 120 may transmit the RLC status report in order to report one or more RLC ACKs (for example, so that the network node 110 may empty a Tx buffer). In one example, the UE 120 may refrain from transmitting an additional RLC status report associated with the transport block 530 in response to hole detection at the UE 120. Instead, the UE 120 may transmit the RLC status report associated with the transport block in response to polling from the network node 110 (for example, in cases where the network node 110 requests for the UE 120 to transmit the RLC status report).

In response to receiving the unsuccessful HARQ process termination indication 545, the network node 110 may determine to transmit one or more ARQ retransmissions associated with the transport block 530. In cases where the network node 110 transmits the control information 540 scheduling a transport block having the same HARQ identifier 520 as the transport block 530 prior to the UE 120 successfully decoding the transport block 530 as a result of a NACK to ACK error, the network node 110 may be triggered to perform the one or more ARQ retransmissions associated with the transport block 530 in response to receiving the unsuccessful HARQ process termination indication 545. Additionally, in cases where the network node 110 transmits the control information 540 scheduling a transport block having the same HARQ identifier 520 as the transport block 530 prior to the UE 120 successfully decoding the transport block 530 as a result of the network node 110 giving up the HARQ retransmission process associated with the transport block 530 (for example, duc to a quantity of retransmissions associated with the transport block 530 satisfying a threshold), the network node 110 may perform the one or more ARQ retransmissions independently of receiving the unsuccessful HARQ process termination indication 545.

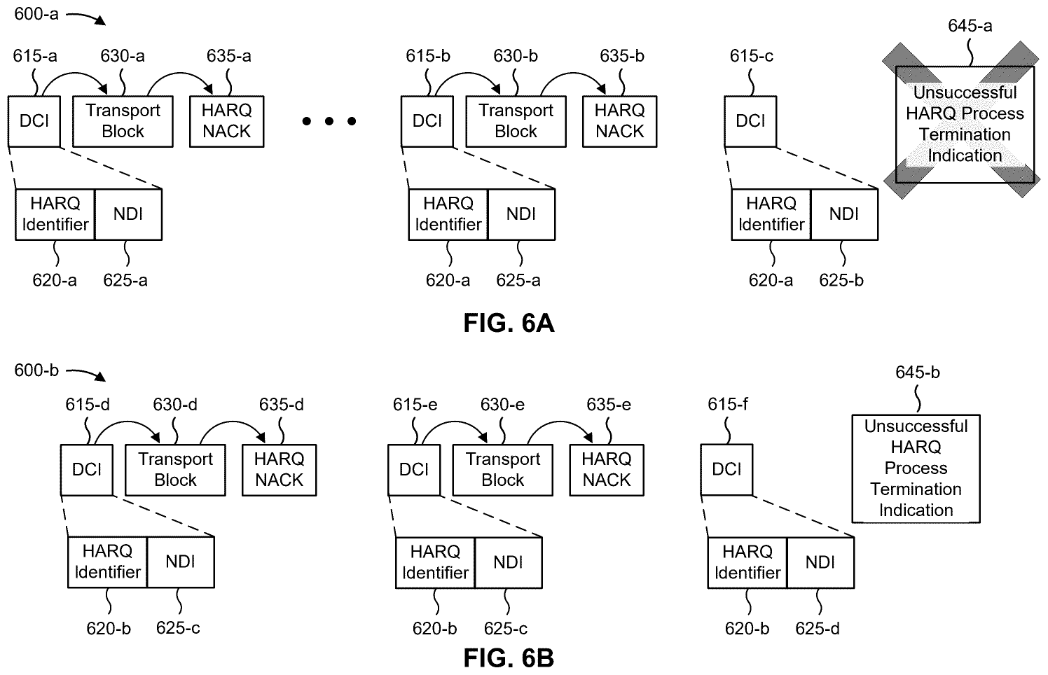

FIGS. 6A and 6B are diagrams illustrating examples 600 of signaling exchanged between a transmitting and receiving device (for example, between a network node and a UE), in accordance with the present disclosure.

FIGS. 6A and 6B illustrate examples 600 where the network node has configured a threshold associated with retransmissions of a transport block 630. In particular, the network node may indicate (for example, via the configuration 510 as described with reference to FIG. 5) for the UE to refrain from transmitting an unsuccessful HARQ process termination indication 645 in cases where a quantity of retransmissions associated with the transport block 630 has exceeded a quantity threshold. That is, if the quantity of retransmissions associated with the transport block 630 is less than (or, in some cases, equal to) the threshold and the UE identifies an unsuccessful termination of a HARQ process associated with the transport block, the UE may transmit the unsuccessful HARQ process termination indication 645. Additionally, if the quantity of retransmissions associated with the transport block 630 is greater than (or, in some cases, equal to) the threshold and the UE identifies an unsuccessful termination of a HARQ process associated with the transport block, the UE may not transmit the unsuccessful HARQ process termination indication 645.

The network node may transmit signaling to the UE configuring the quantity threshold. For example, the network node may transmit (for example, via RRC signaling, via the configuration 510 as described with reference to FIG. 5) signaling indicating the quantity threshold (for example, a max_HARQ_ReTx).

The UE refraining from transmitting the unsuccessful HARQ process termination indication 645 in cases where the quantity of retransmissions associated with the transport block 630 is greater than (or, in some cases, equal to) the threshold may decrease a likelihood that the UE transmits the unsuccessful HARQ process termination indication 645 when the network node has given up the HARQ retransmission process (for example, instead of unsuccessfully terminating the HARQ process as a result of a NACK to ACK error), which may in turn reduce a signaling overhead associated with the UE attempting to identify and report unsuccessful HARQ process terminations.

In the example 600-a, the DCI 615-a may schedule an initial transmission of the transport block 630-a, and may indicate that the transport block 630-a is associated with the HARQ identifier 620-a and an NDI 625-a. However, the UE may be unable to successfully decode the initial transmission of the transport block 630-a, and may transmit a HARQ NACK 635-a to the network node. The network node may schedule one or more retransmissions of the transport block 630-b (for example, via the DCIs 615-b which each indicate the same HARQ identifier 620-a and NDI 625-a as the initial transmission of the transport block 630-a). In cases where the UE is unable to successfully decode the transport block 630 (for example, using a combination of the initial transmission of the transport block 630-a and the one or more retransmissions of the transport block 630-b), the UE may continue to transmit HARQ NACKs 635-b associated with the transport block 630.

If the UE receives the DCI 615-c scheduling another transport block (for example, different from the transport block 630) having the same HARQ identifier 620-a as the transport block 630, but with a different NDI 625-b than the transport block 630, the UE may identify an unsuccessful termination of the HARQ process associated with the transport block 630. However, in example 600-a, the quantity of retransmissions associated with the transport block 630 may be greater than or equal to the threshold. Accordingly, the UE may refrain from transmitting the unsuccessful HARQ process termination indication 645-a. For example, the network node may transmit four retransmissions of the transport block 630. In cases where the threshold is four, the UE may refrain from transmitting the unsuccessful HARQ process termination indication 645-a in response to the quantity of retransmissions (four) being equal to the quantity threshold (four).

In the example 600-b, the DCI 615-d may schedule an initial transmission of the transport block 630-d, and may indicate that the transport block 630-d is associated with the HARQ identifier 620-b and an NDI 625-c. However, the UE may be unable to successfully decode the initial transmission of the transport block 630-d, and may transmit a HARQ NACK 635-d to the network node. The network node may schedule another retransmission of the transport block 630-e (for example, via the DCIs 615-c which each indicate the same HARQ identifier 620-b and NDI 625-c as the initial transmission of the transport block 630-d). In cases where the UE is unable to successfully decode the transport block 630 (for example, using a combination of the initial transmission of the transport block 630-d and the retransmission of the transport block 630-c), the UE may transmit another HARQ NACK 635-e associated with the transport block 630.

If the UE receives the DCI 615-f scheduling another transport block (for example, different from the transport block 630) having the same HARQ identifier 620-b as the transport block 630, but with a different NDI 625-d than the transport block 630, the UE may identify an unsuccessful termination of the HARQ process associated with the transport block 630. Additionally, in example 600-b, the quantity of retransmissions associated with the transport block 630 may be less than or equal to the threshold. Accordingly, the UE may transmit the unsuccessful HARQ process termination indication 645-b. For example, the network node may transmit two transmissions associated with the transport block 630. In cases where the threshold quantity is four, the UE may transmit the unsuccessful HARQ process termination indication 645-b in response to the quantity of transmissions (two) being less than the threshold (four).

In some cases, the UE may detect less retransmissions associated with a transport block 630 than the network node transmits. For example, the UE may not successfully receive or detect a DCI 615 scheduling a retransmission associated with the transport block 630. Here, the UE may incorrectly determine that the quantity of retransmissions associated with the transport block 630 is less than the threshold. Here, the UE may transmit the unsuccessful HARQ process termination indication 645.

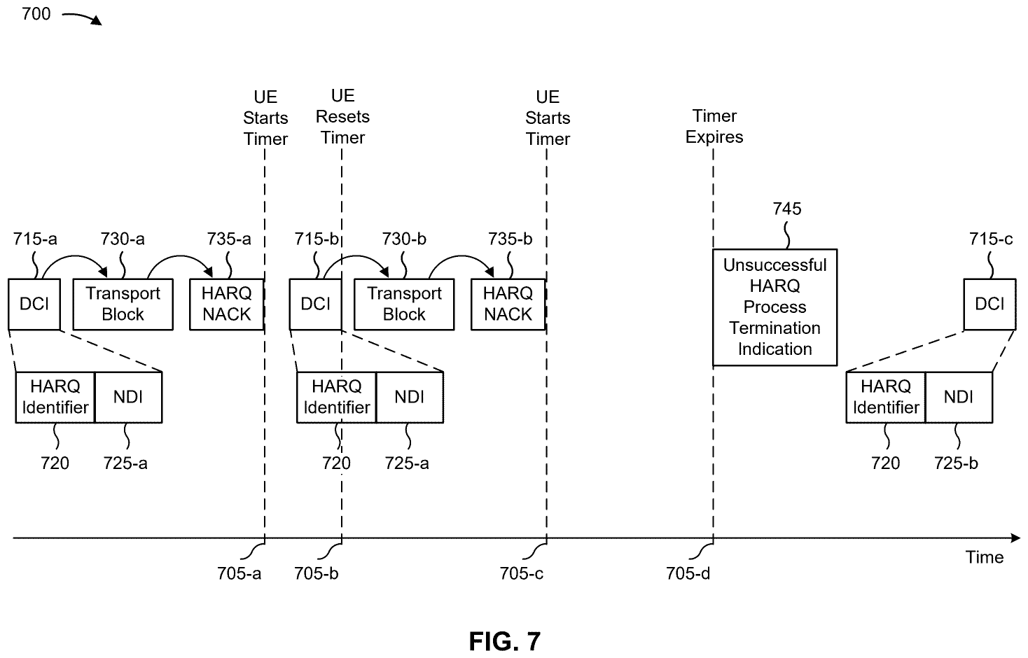

FIG. 7 is a diagram illustrating an example 700 of signaling exchanged between a transmitting and receiving device (for example, between a network node and a UE), in accordance with the present disclosure.

FIG. 7 illustrates an example where the network node configures a timer associated with the UE identifying unsuccessful terminations of HARQ processes. In particular, the network node may indicate (for example, via the configuration 510 as described with reference to FIG. 5) for the UE to identify an unsuccessful HARQ process termination in response to an expiration of a timer. In particular, the UE may start the timer in response to transmitting a HARQ NACK 735 for a transport block 730. If the timer expires prior to the UE detecting a retransmission associated with the transport block 730 or prior to the UE detecting a DCI 715 scheduling a new transport block associated with the same HARQ identifier 720 (such as a DCI 715 indicating the same HARQ identifier 720 but a different NDI 725), the UE may identify an unsuccessful termination of the HARQ process associated with the transport block 730.

The network node may transmit signaling to the UE configuring a value for the timer. For example, the network node may transmit (for example, via RRC signaling, via the configuration 510 as described with reference to FIG. 5) signaling indicating the value for the timer.

In the example 700, the DCI 715-a may schedule an initial transmission of the transport block 730-a, and may indicate that the transport block 730-a is associated with the HARQ identifier 720 and an NDI 725-a. However, the UE may be unable to successfully decode the initial transmission of the transport block 730-a, and at time 705-a may transmit a HARQ NACK 735-a to the network node and start (for example, initiate) the timer. At time 705-b, the network node may schedule a retransmission of the transport block 730-b (for example, via the DCI 715-b which indicates the same HARQ identifier 720 and NDI 725-a as the initial transmission of the transport block 730-a). Additionally, if the UE receives a DCI 715-b that indicates a same HARQ identifier 720 (for example, with the same or different NDI 725), the UE may stop and reset the timer. Therefore, at time 705-b, the UE may stop and reset the timer based on the DCI 715-b indicating the same HARQ identifier 720 as the DCI 715-a. In the example 700, the UE receives the DCI 715-b scheduling the retransmission of the transport block 730-b prior to the expiration of the timer. Accordingly, the UE does not detect an unsuccessful termination of the HARQ process associated with the transport block 730 between times 705-a and 705-b.

In the example 700, the UE is unable to successfully decode the transport block 730 using a combination of the initial transmission of the transport block 730-a and the retransmission of the transport block 730-b. Accordingly, at time 705-c the UE transmits another HARQ NACK 735-b associated with the transport block 730 and starts (for example, initiates) the timer.

At time 705-d, the timer may expire. In response to the timer expiring prior to the UE detecting any control information 715 scheduling another retransmission associated with the transport block 730, the UE may identify an unsuccessful HARQ process termination associated with the transport block 730 and the HARQ identifier 720. Accordingly, the UE may transmit the unsuccessful HARQ process termination indication 745 to the network node.

In some cases, the network node configuring the UE to identify unsuccessful HARQ process terminations in response to an expiration of a timer may decrease a latency associated with the UE detecting and reporting unsuccessful HARQ process terminations. For example, the network node may not transmit another DCI 715-c scheduling another transport block associated with the same HARQ identifier 720 and the NDI 725-b, which may be different from the NDI 725-a, for a long time. In the example 700, if the UE was unable to detect or report the unsuccessful termination of the HARQ process associated with the transport block 730 until the UE received the DCI 715-c, additional latency may be introduced due to the network node initiating an ARQ process to retransmit one or more RLC SDUs or RLC SDU segments associated with the transport block 730. In another example, the UE may fail to receive or decode the DCI 715-c scheduling the other transport block with the same HARQ identifier 720 as the transport block 730. Here, the UE may fail to identify the unsuccessful termination of the HARQ process associated with the transport block 730 without the timer.

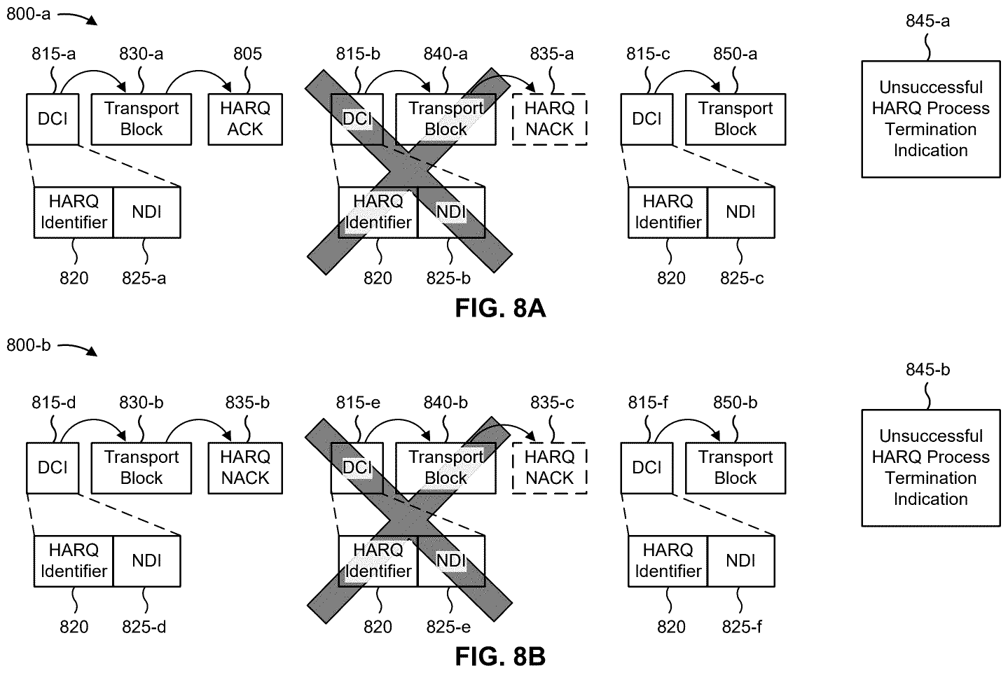

FIGS. 8A and 8B are diagrams illustrating examples 800 of signaling exchanged between a transmitting device and a receiving device (for example, between a network node and a UE), in accordance with the present disclosure.

FIGS. 8A and 8B illustrate examples where a UE fails to receive or decode the control information (for example, the DCI 815-b and the DCI 815-c) scheduling a new transport block 840 associated with a same HARQ identifier 820 as a previously-transmitted transport block 830. In this example, the UE may essentially report a HARQ NACK 835 to the network node related to the transport block 840. For example, the UE may transmit a HARQ NACK 835 or the UE may not transmit any HARQ feedback associated with the transport block 840. In either case, the UE may indicate, to the network node, that the UE was unable to successfully decode the new transport block 840. However, in a case of a NACK to ACK error, the network node may subsequently schedule another transport block 850 associated with the same HARQ identifier 820 (for example, while the UE has not successfully decoded the new transport block 840).

In cases where the NDI 825 associated with the HARQ identifier 820 includes a single bit, the NDI 825 associated with a first transport block 830 (for example, the NDIs 825-a and 825-d) may have a same value as the NDIs 825 associated with the third transport block 850 (for example, the NDIs 825-c and 825-f). In cases where the NDIs 825 associated with the first transport blocks 830 and the third transport blocks 850 have a same value and the UE has failed to detect the DCI 815 scheduling the second transport block 840, the UE may not detect or report the unsuccessful termination of the HARQ process associated with the second transport block 840.

To enable the UE to identify unsuccessful terminations of HARQ processes even in cases where the DCI 815 scheduling a transport block 840 is not detected by the UE, the NDI 825 may be configured with more than one bit, the UE may be configured to evaluate one or more additional conditions associated with the DCI 815 scheduling transport blocks, or both.

In the example 800-a, the DCI 815-a may schedule the transmission of the transport block 830-a, and may indicate that the transport block 830-a is associated with the HARQ identifier 820 and an NDI 825-a. The UE may successfully receive and decode the transport block 830-a, and may transmit the HARQ ACK 805 indicating the successful decoding of the transport block 830-a. Then, the network node may transmit the DCI 815-b to schedule the transmission of another transport block 840-a, and may indicate that the transport block 840-a is associated with the same HARQ identifier 820 and a different NDI 825-b as the first transport block 830-a. However, the UE may not successfully detect, receive, or decode the DCI 815-b. Accordingly, the UE may indicate the failure of the UE to successfully decode the transport block 840-a (for example, via transmitting the HARQ NACK 835-a or by refraining from transmitting any HARQ signaling associated with the transport block 840-a). However, in the example 800-a, there may be a NACK to ACK error associated with the transport block 840-a, and the network node may subsequently schedule another transport block 850-a associated with the same HARQ identifier 820 (for example, while the UE has not successfully decoded the new transport block 840-a). Additionally, the network node may unsuccessfully terminate the HARQ process associated with the transport block 840-a based on the NACK to ACK error.

The network node may transmit the DCI 815-c to schedule the transmission of the third transport block 850-a associated with the same HARQ identifier 820 as the first transport block 830-a and the second transport block 840-a, and associated with the NDI 825-c.

In some cases, the NDIs 825 may include more than one bit (for example, may include K bits, where K>1). Here, the UE may identify the NACK to ACK error associated with the transport block 840-a in response to a difference between a value of the NDI 825-c and the NDI 825-a being greater than one (for example, being two or more). In particular, the difference between the NDI 825-a and 825-c being greater than one may indicate, to the UE, that the UE has not successfully decoded at least one transport block 840 associated with the same HARQ identifier 820 when the UE receives another DCI 815-c scheduling a third transport block 850-a associated with the same HARQ identifier 820. Accordingly, the UE may transmit the unsuccessful HARQ process termination indication 845-a indicating the unsuccessful termination of the HARQ process associated with the transport block 840-a.

In some other cases, the NDIs 825 may have a bitwidth of one. Here, the NDI 825-a and the NDI 825-c may be a same value (for example, 1). Additionally, while the NDI 825-b may be a different value (for example, 0), the UE failing to receive the DCI 815-b may prevent the UE from identifying that the NDI 825 associated with the HARQ identifier 820 has toggled. Therefore, the UE may be unable to identify the unsuccessful termination of the HARQ process associated with the transport block 840-a based on the value of the NDI 825. Here, the UE may identify the unsuccessful termination of the HARQ process associated with the transport block 840-a based on one or more other parameters associated with the transport blocks 830 and 850.

For example, the UE may identify the unsuccessful termination of the HARQ process associated with the transport block 840-a if an MCS indicated by the DCI 815-c does not include a reserved value for a coding rate for the third transport block 850-a. That is, in cases where the DCI 815-c is scheduling a retransmission of the transport block 830-a, the DCI 815-c may indicate an MCS via a reserved value for the coding rate for the retransmission. Accordingly, the UE may identify that the DCI 815-c is not scheduling a retransmission of the first transport block 830-a based on the MCS indicated in the DCI 815-c, and may identify the unsuccessful termination of the HARQ process associated with the transport block 840-a.

In another example, the UE may identify the unsuccessful termination of the HARQ process associated with the transport block 840-a if a transport block size indicated by the DCI 815-c is different from a transport block size associated with the first transport block 830-a. That is, in cases where the DCI 815-c is scheduling a retransmission of the transport block 830-a, the DCI 815-c may indicate a same transport block size as the transport block 830-a. Accordingly, the UE may identify that the DCI 815-c is not scheduling a retransmission of the first transport block 830-a based on the transport block size indicated by the DCI 815-c being different than a transport block size associated with the transport block 830-a, and may identify the unsuccessful termination of the HARQ process associated with the transport block 840-a.

In another example, the UE may identify the unsuccessful termination of the HARQ process associated with the transport block 840-a if a redundancy version indicated by the DCI 815-c is 0. That is, in cases where the DCI 815-c is scheduling a retransmission of the transport block 830-a, the DCI 815-c may indicate a redundancy version value other than 0 (for example, which may in turn indicate that the transport block 850-a is not an initial transmission). Accordingly, the UE may identify that the DCI 815-c is not scheduling a retransmission of the first transport block 830-a based on the redundancy version indicated by the DCI 815-c being 0 (which indicates that the transport block 850-a is an initial transmission), and may identify the unsuccessful termination of the HARQ process associated with the transport block 840-a.

Based on identifying the unsuccessful termination of the HARQ process associated with the transport block 840-a, the UE may transmit the unsuccessful HARQ process termination indication 845-a. Additionally, the UE may refrain from soft combining the transport blocks 830-a and 850-a based on identifying that the transport block 850-a is not a retransmission of the transport block 830-a.

In the example 800-b, the UE may additionally fail to successfully decode the first transport block 830-b, and may transmit the HARQ NACK 835-b to indicate, to the network node, the failure of the UE to successfully decode the first transport block 830-b. Additionally, in the example 800-b, there may be an ACK to NACK error associated with the HARQ NACK 835-b. Accordingly, the network node may then unsuccessfully terminate the HARQ process associated with the transport block 830-b and subsequently transmit the DCI 815-e to schedule the transmission of another transport block 840-b. The DCI 815-a may indicate that the transport block 840-b is associated with the same HARQ identifier 820 and a different NDI 825-e as the first transport block 830-b. However, the UE may not successfully detect, receive, or decode the DCI 815-c. Accordingly, the UE may indicate the failure of the UE to successfully decode the transport block 840-b (for example, via transmitting the HARQ NACK 835-c or by refraining from transmitting any HARQ signaling associated with the transport block 840-b).

However, in the example 800-b, there may be a NACK to ACK error associated with the transport block 840-b, and the network node may subsequently schedule another transport block 850-b associated with the same HARQ identifier 820 (for example, while the UE has not successfully decoded the new transport block 840-b or the first transport block 830-b). Additionally, the network node may unsuccessfully terminate the HARQ process associated with the transport block 840-b based on the NACK to ACK error.

The network node may transmit the DCI 815-c to schedule the transmission of the third transport block 850-a associated with the same HARQ identifier 820 as the first transport block 830-a and the second transport block 840-a, and associated with the NDI 825-c.

In some cases, the NDIs 825 may include more than one bit. Here, the UE may identify the NACK to ACK error associated with the transport blocks 830-b and 840-b based on a difference k between a value of the NDI 825-d and the NDI 825-f. For example, the value of the NDI 825-d may be 1, the value of the NDI 825-e may be 2, and the value of the NDI 825-f may be 3. In the example 800-b, the UE may detect a gap of 2 (for example, k=2) in the NDIs 825. In some cases, the difference between the NDI 825-d and 825-f being greater than one may indicate, to the UE, that the UE has not successfully decoded at least one transport block 840 associated with the same HARQ identifier 820 when the UE receives another DCI 815-c scheduling a third transport block 850-a associated with the same HARQ identifier 820. Accordingly, the UE may transmit the unsuccessful HARQ process termination indication 845-b indicating the unsuccessful termination of the HARQ process associated with the transport block 840-b.

In some cases, the UE may report more than one unsuccessful HARQ process termination via the unsuccessful HARQ process termination indication 845-b. For example, if the UE has decoded the transport block 830-b associated with the previously-detected NDI 825-d (for example, and transmitted a HARQ ACK instead of the HARQ NACK 835-b), the UE may report k−1 unsuccessful HARQ process terminations, where k corresponds to the gap in values of detected NDIs 825. Additionally, if the UE has not decoded the transport block 830-b associated with the previously-detected NDI 825-d (for example, and transmitted the HARQ NACK 835-b), the UE may report k unsuccessful HARQ process terminations. Here, the k unsuccessful HARQ process terminations may correspond to the k−1 missing NDIs 825 and the earlier NDI 825-d for which the transport block 830-b was not successfully decoded. In the example 800-b, the UE may report 2 unsuccessful HARQ process terminations.

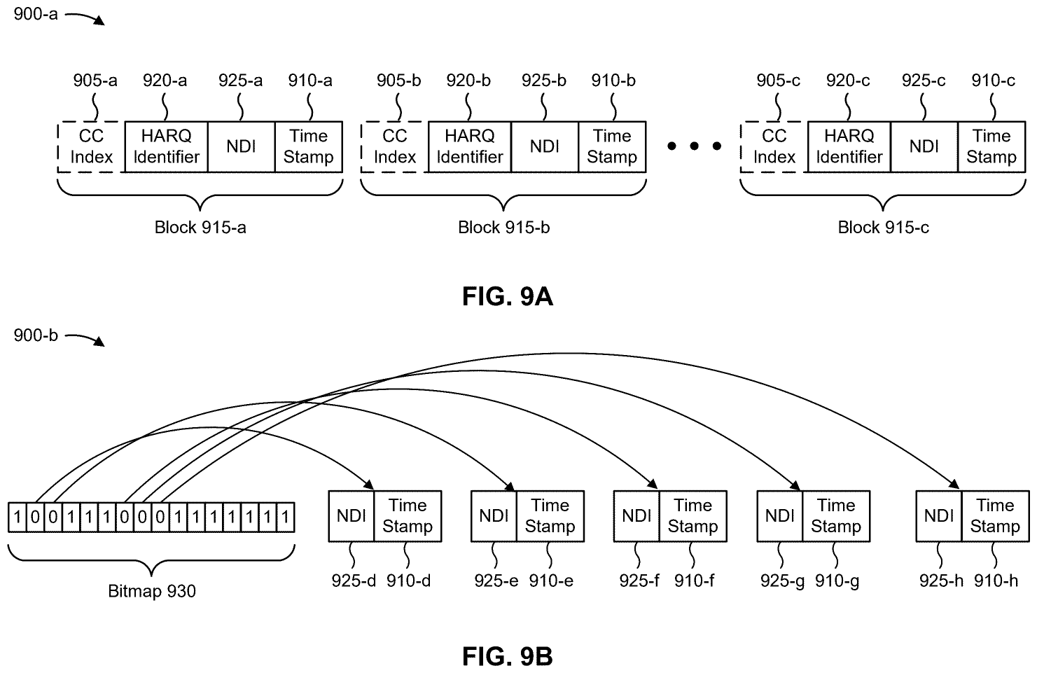

FIGS. 9A and 9B are diagrams illustrating examples 900 of unsuccessful HARQ process termination indications, in accordance with the present disclosure. In some cases, the unsuccessful HARQ process termination indications may be referred to as reports of one or more unsuccessful HARQ termination events.

In the example 900-a, the report of the one or more unsuccessful HARQ termination events may include one or more blocks 915, where for each block 915, the HARQ identifier 920 and NDI 925 associated with the unsuccessfully terminated HARQ process are included. For example, the block 915-a may include a HARQ identifier 920-a and NDI 925-a associated with a first unsuccessfully terminated HARQ process, the block 915-b may include a HARQ identifier 920-b and NDI 925-b associated with a second unsuccessfully terminated HARQ process, and the block 915-c may include a HARQ identifier 920-c and NDI 925-c associated with a third unsuccessfully terminated HARQ process.

In cases where the UE is configured with multiple component carriers, the UE may also include a component carrier index (for example, a CC index 905) for each block 915. For example, the block 915-a may include a first CC index 905-a associated with the first unsuccessfully terminated HARQ process, the block 915-b may include a second CC index 905-b associated with the second unsuccessfully terminated HARQ process, and the block 915-c may include a third CC index 905-c associated with the third unsuccessfully terminated HARQ process.

The report of the one or more unsuccessful HARQ termination events may additionally include a time stamp 910 corresponding to the unsuccessful HARQ process associated with each block 915. For example, in cases where the report is transmitted via a MAC-CE, the report may include the time stamps 910. The time stamp 910 may correspond to a slot number, a subframe number, and/or a system frame number.

In some cases, the time stamp 910 may correspond to a time that the control information scheduling a transport block associated with the unsuccessfully terminated HARQ process is transmitted or received, a time that the transport block associated with the unsuccessfully terminated HARQ process is transmitted or received, a time that the UE transmits a HARQ NACK associated with the unsuccessfully terminated HARQ process, a time that control information scheduling another transport block associated with the same HARQ identifier 920 (for example, and received while the UE has not successfully decoded the transport block associated with the unsuccessfully terminated HARQ process) is transmitted or received (which may correspond to the time when the UE detects the unsuccessful HARQ process termination), and/or a time that the unsuccessfully terminated HARQ process is indicated (for example, to the network node) for a first time.

In the example 900-b, the report may include a bitmap 930 of HARQ identifiers, where each bit in the bitmap 930 indicates a status associated with a corresponding HARQ identifier. For example, if a bit in the bitmap 930 has a first value (for example, 0), the bit may indicate that the UE identified that a HARQ process associated with that HARQ identifier had been unsuccessfully terminated. Additionally, if a bit in the bitmap 930 has a second value (for example, 1), the bit may indicate that the UE did not identify that a HARQ process associated with that HARQ identifier had been unsuccessfully terminated. In the example 900-b, the bitmap 930 may indicate that the UE identified five unsuccessfully terminated HARQ processes, and a mapping associated with the bitmap 930 may indicate the five HARQ identifiers associated with each of the five unsuccessfully terminated HARQ processes.

The report may additionally include, for each HARQ identifier indicated via the bitmap 930 as being associated with an unsuccessfully terminated HARQ process, an NDI 925 associated with the unsuccessfully terminated HARQ process for that HARQ identifier. In the example of 900-b, the report may include a first NDI 925-d associated with a first HARQ process identified as unsuccessfully terminated (for example, corresponding to the first bit in the bitmap 930 having the value of 0), a second NDI 925-e associated with a second HARQ process identified as unsuccessfully terminated (for example, corresponding to the second bit in the bitmap 930 having the value of 0), a third NDI 925-f associated with a third HARQ process identified as unsuccessfully terminated (for example, corresponding to the third bit in the bitmap 930 having the value of 0), a fourth NDI 925-g associated with a fourth HARQ process identified as unsuccessfully terminated (for example, corresponding to the fourth bit in the bitmap 930 having the value of 0), and a fifth NDI 925-h associated with a fifth HARQ process identified as unsuccessfully terminated (for example, corresponding to the fifth bit in the bitmap 930 having the value of 0).

Additionally or alternatively, the report may include time stamps 910 associated with each of the unsuccessfully terminated HARQ processes identified in the bitmap 930 (for example, as described with reference to example 900-a).

In cases where the UE is configured with multiple component carriers, the report may include bitmaps 930 that are associated with each component carrier. For example, the report may include a first bitmap 930 (and corresponding NDIs 925 and time stamps 910) associated with a first component carrier configured for the UE, and a second, distinct, bitmap 930 (and corresponding NDIs 925 and time stamps 910) associated with a second component carrier configured for the UE.

In some instances, the report illustrated by example 900-b may be associated with a lower signaling overhead in cases where the UE identifies many unsuccessfully terminated HARQ processes, as compared to the report illustrated by example 900-a.

In some other examples 900 of a report, the UE may transmit signaling indicating one or more unsuccessful terminations of HARQ processes using an enhanced Type 3 HARQ-ACK codebook. For example, the HARQ-ACK codebook may include values corresponding to a HARQ ACK or HARQ NACK for multiple NDIs 925 associated with each HARQ identifier. For example, in cases where a HARQ identifier is associated with two NDIs, the HARQ-ACK codebook may include values to indicate a HARQ ACK or NACK for both NDIs associated with that HARQ identifier.

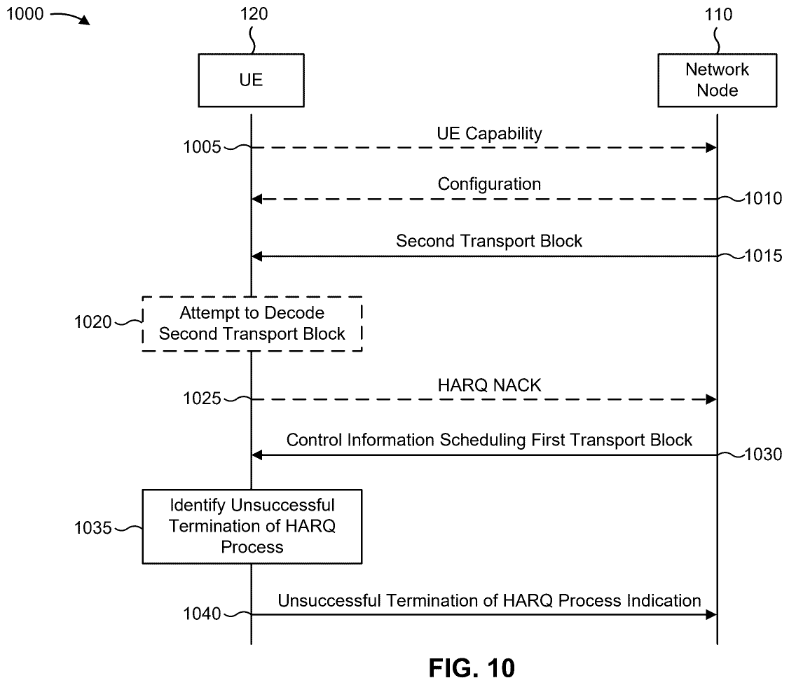

FIG. 10 is a diagram illustrating an example 1000 of signaling exchanged between a network node 110 and a UE 120, in accordance with the present disclosure. In some cases, the network node 110 and the UE 120 may implement aspects of other examples described herein.

At 1005, the UE 120 may optionally transmit, and the network node 110 may receive, signaling indicating a capability of the UE to report unsuccessful terminations of HARQ processes to the network node 110.

At 1010, the network node 110 may optionally transmit, and the UE 120 may receive, signaling indicating a configuration for the UE 120 to report, to the network node 110, unsuccessful terminations of HARQ processes.

At 1015, the network node 110 may transmit, and the UE 120 may optionally attempt to receive (for example, by monitoring a set of resources associated with the transmission of the second transport block), a second transport block (for example, via PDSCH) that is associated with a HARQ identifier.

At 1020, the UE 120 may optionally attempt to decode the second transport block. At 1025, the UE 120 may optionally transmit a HARQ NACK associated with the second transport block. For example, if the UE 120 is unable to successfully decode the second transport block 1020 (for example, and the UE 120 is aware that the second transport block was transmitted by the network node 110 to the UE 120), the UE 120 may transmit the HARQ NACK to the network node 110.

At 1030, the network node 110 may transmit, and the UE 120 may receive, control information scheduling a first transport block and indicating that the first transport block has the same HARQ identifier as the second transport block.

At 1035, the UE 120 may identify an unsuccessful termination of a HARQ process associated with the second transport block. For example, the UE 120 may identify the unsuccessful termination of the HARQ process in response to receiving the control information scheduling another transport block (for example, the first transport block) while the UE 120 has not successfully decoded a previously-received transport block (for example, the second transport block) associated with same HARQ identifier. Additionally or alternatively, the UE 120 may identify the unsuccessful termination of the HARQ process in response to an NDI associated with the first transport block (for example, as indicated by the control information that schedules the first transport block) and the HARQ identifier being the same as the HARQ identifier associated with the second transport block.

At 1040, the UE 120 may transmit, and the network node 110 may receive, signaling indicating the unsuccessful termination of the HARQ process associated with the second transport block. In some cases, the signaling indicating the unsuccessful termination of the HARQ process associated with the second transport block may be transmitted via a report illustrated by the examples 900, within an RLC status report, and/or via an enhanced Type 3 HARQ-ACK codebook.

In some cases, the network node 110 may initiate an ARQ process associated with retransmitting one or more RLC SDU or RLC SDU segments associated with the second transport block in response to receiving the signaling indicating the unsuccessful termination of the HARQ process associated with the second transport block.

FIG. 11 is a flowchart illustrating an example process 1100 performed, for example, at a UE or an apparatus of a UE that supports wireless communication in accordance with the present disclosure. Example process 1100 is an example where the apparatus or the UE (for example, UE 120) performs operations associated with identifying unsuccessful terminations of HARQ processes.

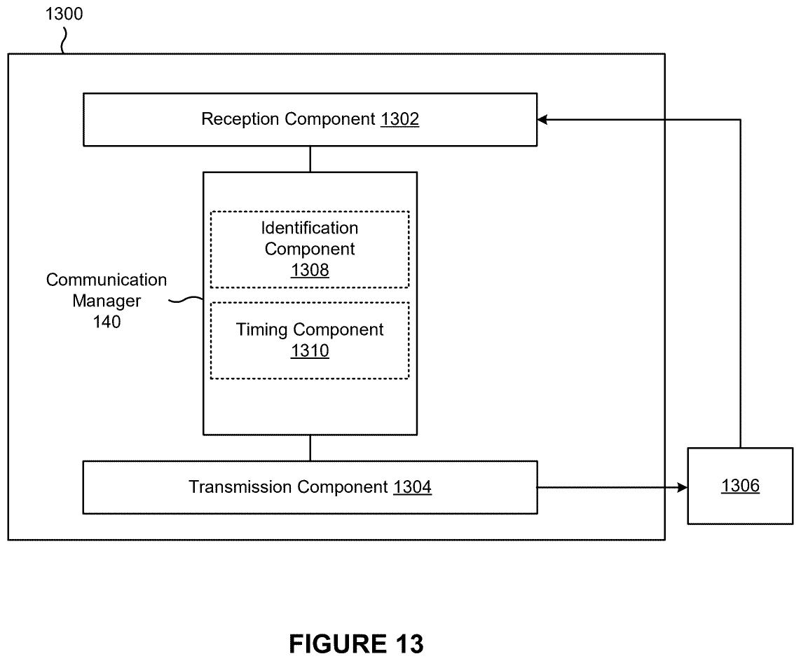

As shown in FIG. 11, in some aspects, process 1100 may include receiving, from a network node, control information scheduling a first transport block and indicating that the first transport block has a same HARQ identifier as a second transport block (block 1110). For example, the UE (such as by using communication manager 140 or reception component 1302, depicted in FIG. 13) may receive, from a network node, control information scheduling a first transport block and indicating that the first transport block has a same HARQ identifier as a second transport block, as described above.

As further shown in FIG. 11, in some aspects, process 1100 may include identifying an unsuccessful termination of a HARQ process associated with the second transport block in response to a failure of the UE to successfully decode the second transport block, the control information scheduling the first transport block having the same HARQ identifier as the second transport block, or both (block 1120). For example, the UE (such as by using communication manager 140 or identification component 1308, depicted in FIG. 13) may identify an unsuccessful termination of a HARQ process associated with the second transport block in response to a failure of the UE to successfully decode the second transport block, the control information scheduling the first transport block having the same HARQ identifier as the second transport block, or both, as described above.

As further shown in FIG. 11, in some aspects, process 1100 may include transmitting, to the network node, signaling indicating the unsuccessful termination of the HARQ process associated with the second transport block (block 1130). For example, the UE (such as by using communication manager 140 or transmission component 1304, depicted in FIG. 13) may transmit, to the network node, signaling indicating the unsuccessful termination of the HARQ process associated with the second transport block, as described above.

Process 1100 may include additional aspects, such as any single aspect or any combination of aspects described below or in connection with one or more other processes described elsewhere herein.

In a first additional aspect, the control information scheduling the first transport block indicates a change in value of an NDI associated with the same HARQ identifier.

In a second additional aspect, alone or in combination with the first aspect, transmitting the signaling indicating the unsuccessful termination of the HARQ process is in response to a quantity of retransmissions associated with the second transport block being less than a threshold.

In a third additional aspect, alone or in combination with one or more of the first and second aspects, process 1100 includes receiving, from the network node, second signaling indicating the threshold.

In a fourth additional aspect, alone or in combination with one or more of the first through third aspects, process 1100 includes transmitting, to the network node prior to receiving the control information scheduling the first transport block, a NACK associated with the second transport block.

In a fifth additional aspect, alone or in combination with one or more of the first through fourth aspects, process 1100 includes initiating a timer in response to transmitting the HARQ NACK associated with the second transport block, wherein transmitting the signaling indicating the unsuccessful termination of the HARQ process is in response to an expiration of the timer.

In a sixth additional aspect, alone or in combination with one or more of the first through fifth aspects, transmitting the signaling indicating the unsuccessful termination of the HARQ process occurs prior to receiving the control information from the network node.

In a seventh additional aspect, alone or in combination with one or more of the first through sixth aspects, process 1100 includes resetting the timer in response to receiving second control information scheduling the second transport block, wherein the timer is associated with the same HARQ identifier, and wherein resetting the timer is further in response to receiving any control information scheduling transport blocks associated with the same HARQ identifier.

In an eighth additional aspect, alone or in combination with one or more of the first through seventh aspects, process 1100 includes receiving, from the network node, a third transport block having the same HARQ identifier as the first transport block, and transmitting, to the network node prior to receiving the control information scheduling the first transport block, an ACK or a NACK associated with the third transport block, wherein identifying the unsuccessful termination of the termination of the HARQ process is further in response to a first NDI associated with the first transport block and a second NDI associated with the third transport block.

In a ninth additional aspect, alone or in combination with one or more of the first through eighth aspects, identifying the unsuccessful termination of the HARQ process is in response to the first NDI being different from the second NDI.

In a tenth additional aspect, alone or in combination with one or more of the first through ninth aspects, the first NDI and the second NDI each comprise two or more bits, and a difference between a first value associated with the first NDI and a second value associated with the second NDI is two or more.

In an eleventh additional aspect, alone or in combination with one or more of the first through tenth aspects, process 1100 includes identifying a second unsuccessful termination of a second HARQ process associated with the third transport block in response to a failure of the UE to successfully decode the third transport block and the difference being two or more, and transmitting, to the network node, the HARQ NACK associated with the third transport block, wherein the signaling indicating the unsuccessful termination of the HARQ process further indicates the second unsuccessful termination of the second HARQ process.

In a twelfth additional aspect, alone or in combination with one or more of the first through eleventh aspects, the HARQ process and the second HARQ process are associated with a same HARQ identifier.

In a thirteenth additional aspect, alone or in combination with one or more of the first through twelfth aspects, identifying the unsuccessful termination of the HARQ process is further in response to transmitting the HARQ ACK associated with the third transport block and the first NDI and the second NDI being the same.

In a fourteenth additional aspect, alone or in combination with one or more of the first through thirteenth aspects, identifying the unsuccessful termination of the HARQ process is further in response to a first transport block size indicated by the control information being different from a second transport block size associated with the third transport block, an MCS indicated by the control information failing to comprise a reserved value for a coding rate for the first transport block, the control information scheduling an initial transmission of the first transport block, or the control information indicating a value of 0 for a redundancy version of the first transport block.

In a fifteenth additional aspect, alone or in combination with one or more of the first through fourteenth aspects, the signaling indicating the unsuccessful termination of the HARQ process comprises an identifier associated with the HARQ process and an NDI associated with the HARQ process.

In a sixteenth additional aspect, alone or in combination with one or more of the first through fifteenth aspects, the signaling indicating the unsuccessful termination of the HARQ process further comprises an index associated with a component carrier associated with the second transport block, an indication of a time associated with the unsuccessful termination of the HARQ process, or both.

In a seventeenth additional aspect, alone or in combination with one or more of the first through sixteenth aspects, the signaling indicating the unsuccessful termination of the HARQ process comprises a bitmap associated with a plurality of HARQ process identifiers, and a value of a bit in the bitmap associated with the HARQ process indicates the unsuccessful termination of the HARQ process.

In an eighteenth additional aspect, alone or in combination with one or more of the first through seventeenth aspects, the signaling indicating the unsuccessful termination of the HARQ process further comprises an NDI associated with the HARQ process, an indication of a time associated with the unsuccessful termination of the HARQ process, or both.

In a nineteenth additional aspect, alone or in combination with one or more of the first through eighteenth aspects, the signaling indicating the unsuccessful termination of the HARQ process comprises multiple bitmaps that are each associated with a different component carrier.

In a twentieth additional aspect, alone or in combination with one or more of the first through nineteenth aspects, the same HARQ identifier is associated with a first NDI and a second NDI, and the signaling indicating the unsuccessful termination of the HARQ process comprises an acknowledgement (ACK) or NACK for each of the first NDI and the second NDI.

In a twenty-first additional aspect, alone or in combination with one or more of the first through twentieth aspects, transmitting the signaling indicating the unsuccessful termination of the HARQ process comprises transmitting the signaling via uplink control information, a MAC-CE, or a radio link control status report.

In a twenty-second additional aspect, alone or in combination with one or more of the first through twenty-first aspects, process 1100 includes receiving, from the network node, signaling indicating for the UE to report, to the network node, unsuccessful terminations of HARQ processes, wherein transmitting the signaling indicating the unsuccessful termination of the HARQ process is in response to receiving signaling indicating for the UE to report the unsuccessful terminations of HARQ processes.

In a twenty-third additional aspect, alone or in combination with one or more of the first through twenty-second aspects, process 1100 includes transmitting, to the network node, a capability of the UE to report unsuccessful terminations of HARQ processes to the network node, wherein receiving the signaling indicating for the UE to report unsuccessful terminations is in response to transmitting the capability of the UE.

Although FIG. 11 shows example blocks of process 1100, in some aspects, process 1100 may include additional blocks, fewer blocks, different blocks, or differently arranged blocks than those depicted in FIG. 11. Additionally or alternatively, two or more of the blocks of process 1100 may be performed in parallel.

FIG. 12 is a flowchart illustrating an example process 1200 performed, for example, at a network node or an apparatus of a network node that supports wireless communication in accordance with the present disclosure. Example process 1200 is an example where the apparatus or the network node (for example, network node 110) performs operations associated with identifying unsuccessful terminations of HARQ processes.

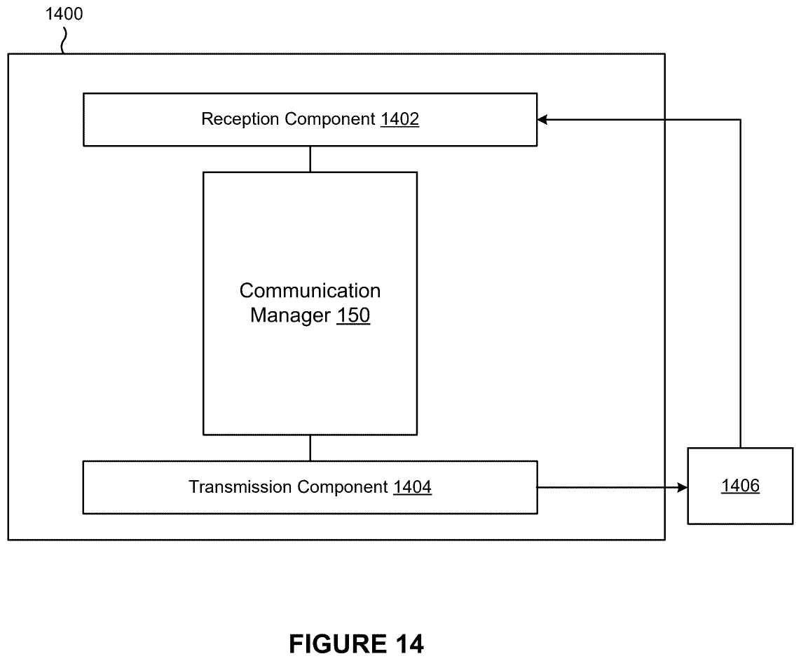

As shown in FIG. 12, in some aspects, process 1200 may include transmitting, to a UE, control information scheduling a first transport block and indicating that the first transport block has a same HARQ identifier as a second transport block (block 1210). For example, the network node (such as by using communication manager 150 or transmission component 1404, depicted in FIG. 14) may transmit, to a UE, control information scheduling a first transport block and indicating that the first transport block has a same HARQ identifier as a second transport block, as described above.

As further shown in FIG. 12, in some aspects, process 1200 may include receiving, from the UE, signaling indicating an unsuccessful termination of a HARQ process associated with the second transport block, wherein receiving the signaling is in response to a failure of the UE to successfully decode the second transport block, the control information scheduling the first transport block having the same HARQ identifier as the second transport block, or both (block 1220). For example, the network node (such as by using communication manager 150 or reception component 1402, depicted in FIG. 1402) may receive, from the UE, signaling indicating an unsuccessful termination of a HARQ process associated with the second transport block, wherein receiving the signaling is in response to a failure of the UE to successfully decode the second transport block, the control information scheduling the first transport block having the same HARQ identifier as the second transport block, or both, as described above.

Process 1200 may include additional aspects, such as any single aspect or any combination of aspects described below or in connection with one or more other processes described elsewhere herein.

In a first additional aspect, the control information scheduling the first transport block indicates a change in value of an NDI associated with the same HARQ identifier.

In a second additional aspect, alone or in combination with the first aspect, receiving the signaling indicating the unsuccessful termination of the HARQ process is further in response to a quantity of retransmissions associated with the second transport block being less than a threshold.

In a third additional aspect, alone or in combination with one or more of the first and second aspects, process 1200 includes transmitting, to the UE, second signaling indicating the threshold.

In a fourth additional aspect, alone or in combination with one or more of the first through third aspects, process 1200 includes receiving, from the UE prior to transmitting the control information scheduling the first transport block, a NACK associated with the second transport block.

In a fifth additional aspect, alone or in combination with one or more of the first through fourth aspects, receiving the signaling indicating the unsuccessful termination of the HARQ process is further in response to an expiration of a timer that is associated with the HARQ identifier.

In a sixth additional aspect, alone or in combination with one or more of the first through fifth aspects, receiving the signaling indicating the unsuccessful termination of the HARQ process occurs prior to transmitting the control information to the UE.

In a seventh additional aspect, alone or in combination with one or more of the first through sixth aspects, process 1200 includes transmitting, to the UE, a third transport block having the same HARQ identifier as the first transport block, and receiving, from the UE prior to transmitting the control information scheduling the first transport block, an ACK or a NACK associated with the third transport block, wherein receiving the signaling indicating the unsuccessful termination of the HARQ process is further in response to a first NDI associated with the first transport block and a second NDI associated with the third transport block.

In an eighth additional aspect, alone or in combination with one or more of the first through seventh aspects, receiving the signaling indicating the unsuccessful termination of the HARQ process is further in response to the first NDI being different from the second NDI.

In a ninth additional aspect, alone or in combination with one or more of the first through eighth aspects, the first NDI and the second NDI each comprise two or more bits, and a difference between a first value associated with the first NDI and a second value associated with the second NDI is two or more.

In a tenth additional aspect, alone or in combination with one or more of the first through ninth aspects, process 1200 includes receiving, from the UE, the HARQ NACK associated with the third transport block, wherein the signaling indicating the unsuccessful termination of the HARQ process further indicates a second unsuccessful termination of a second HARQ process associated with the third transport block, and wherein the signaling indicates the second unsuccessful termination of the second HARQ process in response to a failure of the UE to successfully decode the third transport block and the difference being two or more.

In an eleventh additional aspect, alone or in combination with one or more of the first through tenth aspects, the HARQ process and the second HARQ process are associated with a same HARQ identifier.

In a twelfth additional aspect, alone or in combination with one or more of the first through eleventh aspects, receiving the signaling indicating the unsuccessful termination of the HARQ process is further in response to the HARQ ACK associated with the third transport block and the first NDI and the second NDI being the same.

In a thirteenth additional aspect, alone or in combination with one or more of the first through twelfth aspects, receiving the signaling indicating the unsuccessful termination of the HARQ process is further in response to a first transport block size indicated by the control information being different from a second transport block size associated with the third transport block, an MCS indicated by the control information failing to comprise a reserved value for a coding rate for the first transport block, the control information scheduling an initial transmission of the first transport block, or the control information indicating a value of 0 for a redundancy version of the first transport block.

In a fourteenth additional aspect, alone or in combination with one or more of the first through thirteenth aspects, the signaling indicating the unsuccessful termination of the HARQ process comprises an identifier associated with the HARQ process and an NDI associated with the HARQ process.

In a fifteenth additional aspect, alone or in combination with one or more of the first through fourteenth aspects, the signaling indicating the unsuccessful termination of the HARQ process further comprises an index associated with a component carrier associated with the second transport block, an indication of a time associated with the unsuccessful termination of the HARQ process, or both.

In a sixteenth additional aspect, alone or in combination with one or more of the first through fifteenth aspects, the signaling indicating the unsuccessful termination of the HARQ process comprises a bitmap associated with a plurality of HARQ process identifiers, and a value of a bit in the bitmap associated with the HARQ process indicates the unsuccessful termination of the HARQ process.

In a seventeenth additional aspect, alone or in combination with one or more of the first through sixteenth aspects, the signaling indicating the unsuccessful termination of the HARQ process further comprises an NDI associated with the HARQ process, an indication of a time associated with the unsuccessful termination of the HARQ process, or both.

In an eighteenth additional aspect, alone or in combination with one or more of the first through seventeenth aspects, the signaling indicating the unsuccessful termination of the HARQ process comprises multiple bitmaps that are each associated with a different component carrier.

In a nineteenth additional aspect, alone or in combination with one or more of the first through eighteenth aspects, the same HARQ identifier is associated with a first NDI and a second NDI, and the signaling indicating the unsuccessful termination of the HARQ process comprises an ACK or NACK for each of the first NDI and the second NDI.

In a twentieth additional aspect, alone or in combination with one or more of the first through nineteenth aspects, receiving the signaling indicating the unsuccessful termination of the HARQ process comprises receiving the signaling via uplink control information, a MAC-CE, or a radio link control status report.

In a twenty-first additional aspect, alone or in combination with one or more of the first through twentieth aspects, process 1200 includes transmitting, to the UE, signaling indicating for the UE to report, to the network node, unsuccessful terminations of HARQ processes, wherein receiving the signaling indicating the unsuccessful termination of the HARQ process is in response to transmitting signaling indicating for the UE to report the unsuccessful terminations of HARQ processes.

In a twenty-second additional aspect, alone or in combination with one or more of the first through twenty-first aspects, process 1200 includes receiving, from the UE, a capability of the UE to report unsuccessful terminations of HARQ processes to the network node, wherein transmitting the signaling indicating for the UE to report unsuccessful terminations is in response to receiving the capability of the UE.

Although FIG. 12 shows example blocks of process 1200, in some aspects, process 1200 may include additional blocks, fewer blocks, different blocks, or differently arranged blocks than those depicted in FIG. 12. Additionally or alternatively, two or more of the blocks of process 1200 may be performed in parallel.

FIG. 13 is a diagram of an example apparatus 1300 for wireless communication that supports identifying unsuccessful terminations of HARQ processes in accordance with the present disclosure. The apparatus 1300 may be a UE, or a UE may include the apparatus 1300. In some aspects, the apparatus 1300 includes a reception component 1302, a transmission component 1304, and a communication manager 140, which may be in communication with one another (for example, via one or more buses). As shown, the apparatus 1300 may communicate with another apparatus 1306 (such as a UE, a network node, or another wireless communication device) using the reception component 1302 and the transmission component 1304.

In some aspects, the apparatus 1300 may be configured to and/or operable to perform one or more operations described herein in connection with FIGS. 4-10. Additionally or alternatively, the apparatus 1300 may be configured to and/or operable to perform one or more processes described herein, such as process 1100 of FIG. 11. In some aspects, the apparatus 1300 may include one or more components of the UE described above in connection with FIG. 2.

The reception component 1302 may receive communications, such as reference signals, control information, and/or data communications, from the apparatus 1306. The reception component 1302 may provide received communications to one or more other components of the apparatus 1300, such as the communication manager 140. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 1302 may include one or more antennas, one or more modems, one or more demodulators, one or more MIMO detectors, one or more receive processors, one or more controllers/processors, and/or one or more memories of the UE described above in connection with FIG. 2.

The transmission component 1304 may transmit communications, such as reference signals, control information, and/or data communications, to the apparatus 1306. In some aspects, the communication manager 140 may generate communications and may transmit the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, one or more modems, one or more modulators, one or more transmit MIMO processors, one or more transmit processors, one or more controllers/processors, and/or one or more memories of the UE described above in connection with FIG. 2. In some aspects, the transmission component 1304 may be co-located with the reception component 1302 in one or more transceivers.

The communication manager 140 may receive or may cause the reception component 1302 to receive, from a network node, control information scheduling a first transport block and indicating that the first transport block has a same HARQ identifier as a second transport block. The communication manager 140 may identify an unsuccessful termination of a HARQ process associated with the second transport block in response to a failure of the UE to successfully decode the second transport block, the control information scheduling the first transport block having the same HARQ identifier as the second transport block, or both. The communication manager 140 may transmit or may cause the transmission component 1304 to transmit, to the network node, signaling indicating the unsuccessful termination of the HARQ process associated with the second transport block. In some aspects, the communication manager 140 may perform one or more operations described elsewhere herein as being performed by one or more components of the communication manager 140.

The communication manager 140 may include one or more controllers/processors, one or more memories, of the UE described above in connection with FIG. 2. In some aspects, the communication manager 140 includes a set of components, such as an identification component 1308. Alternatively, the set of components may be separate and distinct from the communication manager 140. In some aspects, one or more components of the set of components may include or may be implemented within one or more controllers/processors, one or more memories of the UE described above in connection with FIG. 2. Additionally or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1302 may receive, from a network node, control information scheduling a first transport block and indicating that the first transport block has a same HARQ identifier as a second transport block. The identification component 1308 may identify an unsuccessful termination of a HARQ process associated with the second transport block in response to a failure of the UE to successfully decode the second transport block, the control information scheduling the first transport block having the same HARQ identifier as the second transport block, or both. The transmission component 1304 may transmit, to the network node, signaling indicating the unsuccessful termination of the HARQ process associated with the second transport block.

The reception component 1302 may receive, from the network node, second signaling indicating the threshold.

The transmission component 1304 may transmit, to the network node prior to receiving the control information scheduling the first transport block, a NACK associated with the second transport block.

The timing component 1310 may initiate a timer in response to transmitting the HARQ NACK associated with the second transport block, wherein transmitting the signaling indicating the unsuccessful termination of the HARQ process is in response to an expiration of the timer.

The timing component 1310 may reset the timer in response to receiving second control information scheduling the second transport block, wherein the timer is associated with the same HARQ identifier, and wherein resetting the timer is further in response to receiving any control information scheduling transport blocks associated with the same HARQ identifier.

The reception component 1302 may receive, from the network node, a third transport block having the same HARQ identifier as the first transport block.

The transmission component 1304 may transmit, to the network node prior to receiving the control information scheduling the first transport block, an ACK or a NACK associated with the third transport block, wherein identifying the unsuccessful termination of the termination of the HARQ process is further in response to a first NDI associated with the first transport block and a second NDI associated with the third transport block.

The identification component 1308 may identify a second unsuccessful termination of a second HARQ process associated with the third transport block in response to a failure of the UE to successfully decode the third transport block and the difference being two or more.

The transmission component 1304 may transmit, to the network node, the HARQ NACK associated with the third transport block, wherein the signaling indicating the unsuccessful termination of the HARQ process further indicates the second unsuccessful termination of the second HARQ process.

The reception component 1302 may receive, from the network node, signaling indicating for the UE to report, to the network node, unsuccessful terminations of HARQ processes, wherein transmitting the signaling indicating the unsuccessful termination of the HARQ process is in response to receiving signaling indicating for the UE to report the unsuccessful terminations of HARQ processes.

The transmission component 1304 may transmit, to the network node, a capability of the UE to report unsuccessful terminations of HARQ processes to the network node, wherein receiving the signaling indicating for the UE to report unsuccessful terminations is in response to transmitting the capability of the UE.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally or alternatively, a set of (one or more) components shown in FIG. 13 may perform one or more functions described as being performed by another set of components shown in FIG. 13.

FIG. 14 is a diagram of an example apparatus 1400 for wireless communication that supports identifying unsuccessful terminations of HARQ processes in accordance with the present disclosure. The apparatus 1400 may be a network node, or a network node may include the apparatus 1400. In some aspects, the apparatus 1400 includes a reception component 1402, a transmission component 1404, and a communication manager 150, which may be in communication with one another (for example, via one or more buses). As shown, the apparatus 1400 may communicate with another apparatus 1406 (such as a UE, a network node, or another wireless communication device) using the reception component 1402 and the transmission component 1404.

In some aspects, the apparatus 1400 may be configured to and/or operable to perform one or more operations described herein in connection with FIGS. 4-10. Additionally or alternatively, the apparatus 1400 may be configured to and/or operable to perform one or more processes described herein, such as process 1200 of FIG. 12. In some aspects, the apparatus 1400 may include one or more components of the network node described above in connection with FIG. 2.

The reception component 1402 may receive communications, such as reference signals, control information, and/or data communications, from the apparatus 1406. The reception component 1402 may provide received communications to one or more other components of the apparatus 1400, such as the communication manager 150. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 1402 may include one or more antennas, one or more modems, one or more demodulators, one or more MIMO detectors, one or more receive processors, one or more controllers/processors, and/or one or more memories of the network node described above in connection with FIG. 2.

The transmission component 1404 may transmit communications, such as reference signals, control information, and/or data communications, to the apparatus 1406. In some aspects, the communication manager 150 may generate communications and may transmit the generated communications to the transmission component 1404 for transmission to the apparatus 1406. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1406. In some aspects, the transmission component 1404 may include one or more antennas, one or more modems, one or more modulators, one or more transmit MIMO processors, one or more transmit processors, one or more controllers/processors, and/or one or more memories of the network node described above in connection with FIG. 2. In some aspects, the transmission component 1404 may be co-located with the reception component 1402 in one or more transceivers.

The communication manager 150 may transmit or may cause the transmission component 1404 to transmit, to a UE, control information scheduling a first transport block and indicating that the first transport block has a same HARQ identifier as a second transport block. The communication manager 150 may receive or may cause the reception component 1402 to receive, from the UE, signaling indicating an unsuccessful termination of a HARQ process associated with the second transport block, wherein receiving the signaling is in response to a failure of the UE to successfully decode the second transport block, the control information scheduling the first transport block having the same HARQ identifier as the second transport block, or both. In some aspects, the communication manager 150 may perform one or more operations described elsewhere herein as being performed by one or more components of the communication manager 150.

The communication manager 150 may include one or more controllers/processors, one or more memories, one or more schedulers, and/or one or more communication units of the network node described above in connection with FIG. 2. In some aspects, the communication manager 150 may include or may be implemented within one or more controllers/processors, one or more memories, one or more schedulers, and/or one or more communication units of the network node described above in connection with FIG. 2. Additionally or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The transmission component 1404 may transmit, to a UE, control information scheduling a first transport block and indicating that the first transport block has a same HARQ identifier as a second transport block. The reception component 1402 may receive, from the UE, signaling indicating an unsuccessful termination of a HARQ process associated with the second transport block, wherein receiving the signaling is in response to a failure of the UE to successfully decode the second transport block, the control information scheduling the first transport block having the same HARQ identifier as the second transport block, or both.

The transmission component 1404 may transmit, to the UE, second signaling indicating the threshold.

The reception component 1402 may receive, from the UE prior to transmitting the control information scheduling the first transport block, a NACK associated with the second transport block.

The transmission component 1404 may transmit, to the UE, a third transport block having the same HARQ identifier as the first transport block.

The reception component 1402 may receive, from the UE prior to transmitting the control information scheduling the first transport block, an ACK or a NACK associated with the third transport block, wherein receiving the signaling indicating the unsuccessful termination of the HARQ process is further in response to a first NDI associated with the first transport block and a second NDI associated with the third transport block.

The reception component 1402 may receive, from the UE, the HARQ NACK associated with the third transport block, wherein the signaling indicating the unsuccessful termination of the HARQ process further indicates a second unsuccessful termination of a second HARQ process associated with the third transport block, and wherein the signaling indicates the second unsuccessful termination of the second HARQ process in response to a failure of the UE to successfully decode the third transport block and the difference being two or more.

The transmission component 1404 may transmit, to the UE, signaling indicating for the UE to report, to the network node, unsuccessful terminations of HARQ processes, wherein receiving the signaling indicating the unsuccessful termination of the HARQ process is in response to transmitting signaling indicating for the UE to report the unsuccessful terminations of HARQ processes.

The reception component 1402 may receive, from the UE, a capability of the UE to report unsuccessful terminations of HARQ processes to the network node, wherein transmitting the signaling indicating for the UE to report unsuccessful terminations is in response to receiving the capability of the UE.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally or alternatively, a set of (one or more) components shown in FIG. 14 may perform one or more functions described as being performed by another set of components shown in FIG. 14.

The following provides an overview of some Aspects of the present disclosure:

Aspect 1: A method of wireless communication by a UE, comprising: receiving, from a network node, control information scheduling a first transport block and indicating that the first transport block has a same HARQ identifier as a second transport block; identifying an unsuccessful termination of a HARQ process associated with the second transport block in response to a failure of the UE to successfully decode the second transport block, the control information scheduling the first transport block having the same HARQ identifier as the second transport block, or both; and transmitting, to the network node, signaling indicating the unsuccessful termination of the HARQ process associated with the second transport block.

Aspect 2: The method of Aspect 1, wherein the control information scheduling the first transport block indicates a change in value of an NDI associated with the same HARQ identifier.

Aspect 3: The method of any of Aspects 1-2, wherein transmitting the signaling indicating the unsuccessful termination of the HARQ process is in response to a quantity of retransmissions associated with the second transport block being less than a threshold.

Aspect 4: The method of Aspect 3, further comprising: receiving, from the network node, second signaling indicating the threshold.

Aspect 5: The method of any of Aspects 1-4, further comprising: transmitting, to the network node prior to receiving the control information scheduling the first transport block, a NACK associated with the second transport block.

Aspect 6: The method of Aspect 5, further comprising: initiating a timer in response to transmitting the HARQ NACK associated with the second transport block, wherein transmitting the signaling indicating the unsuccessful termination of the HARQ process is in response to an expiration of the timer.

Aspect 7: The method of Aspect 6, wherein transmitting the signaling indicating the unsuccessful termination of the HARQ process occurs prior to receiving the control information from the network node.

Aspect 8: The method of Aspect 6, further comprising: resetting the timer in response to receiving second control information scheduling the second transport block, wherein the timer is associated with the same HARQ identifier, and wherein resetting the timer is further in response to receiving any control information scheduling transport blocks associated with the same HARQ identifier.

Aspect 9: The method of any of Aspects 1-8, further comprising: receiving, from the network node, a third transport block having the same HARQ identifier as the first transport block; and transmitting, to the network node prior to receiving the control information scheduling the first transport block, an ACK or a NACK associated with the third transport block, wherein identifying the unsuccessful termination of the termination of the HARQ process is further in response to a first NDI associated with the first transport block and a second NDI associated with the third transport block.

Aspect 10: The method of Aspect 9, wherein identifying the unsuccessful termination of the HARQ process is in response to the first NDI being different from the second NDI.

Aspect 11: The method of Aspect 10, wherein: the first NDI and the second NDI each comprise two or more bits; and a difference between a first value associated with the first NDI and a second value associated with the second NDI is two or more.

Aspect 12: The method of Aspect 11, further comprising: identifying a second unsuccessful termination of a second HARQ process associated with the third transport block in response to a failure of the UE to successfully decode the third transport block and the difference being two or more; and transmitting, to the network node, the HARQ NACK associated with the third transport block, wherein the signaling indicating the unsuccessful termination of the HARQ process further indicates the second unsuccessful termination of the second HARQ process.

Aspect 13: The method of Aspect 12, wherein the HARQ process and the second HARQ process are associated with a same HARQ identifier.

Aspect 14: The method of Aspect 9, wherein identifying the unsuccessful termination of the HARQ process is further in response to transmitting the HARQ ACK associated with the third transport block and the first NDI and the second NDI being the same.

Aspect 15: The method of Aspect 14, wherein identifying the unsuccessful termination of the HARQ process is further in response to: a first transport block size indicated by the control information being different from a second transport block size associated with the third transport block; an MCS indicated by the control information failing to comprise a reserved value for a coding rate for the first transport block; the control information scheduling an initial transmission of the first transport block; or the control information indicating a value of 0 for a redundancy version of the first transport block.

Aspect 16: The method of any of Aspects 1-15, wherein the signaling indicating the unsuccessful termination of the HARQ process comprises an identifier associated with the HARQ process and an NDI associated with the HARQ process.

Aspect 17: The method of Aspect 16, wherein the signaling indicating the unsuccessful termination of the HARQ process further comprises an index associated with a component carrier associated with the second transport block, an indication of a time associated with the unsuccessful termination of the HARQ process, or both.

Aspect 18: The method of any of Aspects 1-17, wherein: the signaling indicating the unsuccessful termination of the HARQ process comprises a bitmap associated with a plurality of HARQ process identifiers; and a value of a bit in the bitmap associated with the HARQ process indicates the unsuccessful termination of the HARQ process.

Aspect 19: The method of Aspect 18, wherein the signaling indicating the unsuccessful termination of the HARQ process further comprises an NDI associated with the HARQ process, an indication of a time associated with the unsuccessful termination of the HARQ process, or both.

Aspect 20: The method of Aspect 18, wherein the signaling indicating the unsuccessful termination of the HARQ process comprises multiple bitmaps that are each associated with a different component carrier.

Aspect 21: The method of any of Aspects 1-20, wherein: the same HARQ identifier is associated with a first NDI and a second NDI; and the signaling indicating the unsuccessful termination of the HARQ process comprises an acknowledgement (ACK) or NACK for each of the first NDI and the second NDI.

Aspect 22: The method of any of Aspects 1-21, wherein transmitting the signaling indicating the unsuccessful termination of the HARQ process comprises transmitting the signaling via uplink control information, a MAC-CE, or a radio link control status report.

Aspect 23: The method of any of Aspects 1-22, further comprising: receiving, from the network node, signaling indicating for the UE to report, to the network node, unsuccessful terminations of HARQ processes, wherein transmitting the signaling indicating the unsuccessful termination of the HARQ process is in response to receiving signaling indicating for the UE to report the unsuccessful terminations of HARQ processes.

Aspect 24: The method of Aspect 22, further comprising: transmitting, to the network node, a capability of the UE to report unsuccessful terminations of HARQ processes to the network node, wherein receiving the signaling indicating for the UE to report unsuccessful terminations is in response to transmitting the capability of the UE.

Aspect 25: A method of wireless communication by a network node, comprising: transmitting, to a UE, control information scheduling a first transport block and indicating that the first transport block has a same HARQ identifier as a second transport block; and receiving, from the UE, signaling indicating an unsuccessful termination of a HARQ process associated with the second transport block, wherein receiving the signaling is in response to a failure of the UE to successfully decode the second transport block, the control information scheduling the first transport block having the same HARQ identifier as the second transport block, or both.

Aspect 26: The method of Aspect 25, wherein the control information scheduling the first transport block indicates a change in value of an NDI associated with the same HARQ identifier.

Aspect 27: The method of any of Aspects 25-26, wherein receiving the signaling indicating the unsuccessful termination of the HARQ process is further in response to a quantity of retransmissions associated with the second transport block being less than a threshold.

Aspect 28: The method of Aspect 27, further comprising: transmitting, to the UE, second signaling indicating the threshold.

Aspect 29: The method of any of Aspects 25-28, further comprising: receiving, from the UE prior to transmitting the control information scheduling the first transport block, a NACK associated with the second transport block.

Aspect 30: The method of Aspect 29, wherein receiving the signaling indicating the unsuccessful termination of the HARQ process is further in response to an expiration of a timer that is associated with the HARQ identifier.

Aspect 31: The method of Aspect 30, wherein receiving the signaling indicating the unsuccessful termination of the HARQ process occurs prior to transmitting the control information to the UE.

Aspect 32: The method of any of Aspects 25-31, further comprising: transmitting, to the UE, a third transport block having the same HARQ identifier as the first transport block; and receiving, from the UE prior to transmitting the control information scheduling the first transport block, an ACK or a NACK associated with the third transport block, wherein receiving the signaling indicating the unsuccessful termination of the HARQ process is further in response to a first NDI associated with the first transport block and a second NDI associated with the third transport block.

Aspect 33: The method of Aspect 32, wherein receiving the signaling indicating the unsuccessful termination of the HARQ process is further in response to the first NDI being different from the second NDI.

Aspect 34: The method of Aspect 33, wherein: the first NDI and the second NDI each comprise two or more bits; and a difference between a first value associated with the first NDI and a second value associated with the second NDI is two or more.

Aspect 35: The method of Aspect 34, further comprising: receiving, from the UE, the HARQ NACK associated with the third transport block, wherein the signaling indicating the unsuccessful termination of the HARQ process further indicates a second unsuccessful termination of a second HARQ process associated with the third transport block, and wherein the signaling indicates the second unsuccessful termination of the second HARQ process in response to a failure of the UE to successfully decode the third transport block and the difference being two or more.

Aspect 36: The method of Aspect 35, wherein the HARQ process and the second HARQ process are associated with a same HARQ identifier.

Aspect 37: The method of Aspect 32, wherein receiving the signaling indicating the unsuccessful termination of the HARQ process is further in response to the HARQ ACK associated with the third transport block and the first NDI and the second NDI being the same.

Aspect 38: The method of Aspect 37, wherein receiving the signaling indicating the unsuccessful termination of the HARQ process is further in response to: a first transport block size indicated by the control information being different from a second transport block size associated with the third transport block; an MCS indicated by the control information failing to comprise a reserved value for a coding rate for the first transport block; the control information scheduling an initial transmission of the first transport block; or the control information indicating a value of 0 for a redundancy version of the first transport block.

Aspect 39: The method of any of Aspects 25-38, wherein the signaling indicating the unsuccessful termination of the HARQ process comprises an identifier associated with the HARQ process and an NDI associated with the HARQ process.

Aspect 40: The method of Aspect 39, wherein the signaling indicating the unsuccessful termination of the HARQ process further comprises an index associated with a component carrier associated with the second transport block, an indication of a time associated with the unsuccessful termination of the HARQ process, or both.

Aspect 41: The method of any of Aspects 25-40, wherein: the signaling indicating the unsuccessful termination of the HARQ process comprises a bitmap associated with a plurality of HARQ process identifiers; and a value of a bit in the bitmap associated with the HARQ process indicates the unsuccessful termination of the HARQ process.

Aspect 42: The method of Aspect 41, wherein the signaling indicating the unsuccessful termination of the HARQ process further comprises an NDI associated with the HARQ process, an indication of a time associated with the unsuccessful termination of the HARQ process, or both.

Aspect 43: The method of Aspect 41, wherein the signaling indicating the unsuccessful termination of the HARQ process comprises multiple bitmaps that are each associated with a different component carrier.

Aspect 44: The method of any of Aspects 25-43, wherein: the same HARQ identifier is associated with a first NDI and a second NDI; and the signaling indicating the unsuccessful termination of the HARQ process comprises an acknowledgement (ACK) or NACK for each of the first NDI and the second NDI.

Aspect 45: The method of any of Aspects 25-44, wherein receiving the signaling indicating the unsuccessful termination of the HARQ process comprises receiving the signaling via uplink control information, a MAC-CE, or a radio link control status report.

Aspect 46: The method of any of Aspects 25-45, further comprising: transmitting, to the UE, signaling indicating for the UE to report, to the network node, unsuccessful terminations of HARQ processes, wherein receiving the signaling indicating the unsuccessful termination of the HARQ process is in response to transmitting signaling indicating for the UE to report the unsuccessful terminations of HARQ processes.

Aspect 47: The method of Aspect 46, further comprising: receiving, from the UE, a capability of the UE to report unsuccessful terminations of HARQ processes to the network node, wherein transmitting the signaling indicating for the UE to report unsuccessful terminations is in response to receiving the capability of the UE.

Aspect 48: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-47.

Aspect 49: An apparatus for wireless communication at a device, the apparatus comprising one or more memories and one or more processors coupled to the one or more memories, the one or more processors configured to cause the device to perform the method of one or more of Aspects 1-47.

Aspect 50: An apparatus for wireless communication, the apparatus comprising at least one means for performing the method of one or more of Aspects 1-47.

Aspect 51: A non-transitory computer-readable medium storing code for wireless communication, the code comprising instructions executable by one or more processors to perform the method of one or more of Aspects 1-47.

Aspect 52: A non-transitory computer-readable medium storing a set of instructions for wireless communication, the set of instructions comprising one or more instructions that, when executed by one or more processors of a device, cause the device to perform the method of one or more of Aspects 1-47.

Aspect 53: A device for wireless communication, the device comprising a processing system that includes one or more processors and one or more memories coupled with the one or more processors, the processing system configured to cause the device to perform the method of one or more of Aspects 1-47.

Aspect 54: An apparatus for wireless communication at a device, the apparatus comprising one or more memories and one or more processors coupled to the one or more memories, the one or more processors individually or collectively configured to cause the device to perform the method of one or more of Aspects 1-47.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. A user equipment (UE) for wireless communication, comprising:
a processing system that includes one or more processors and one or more memories coupled with the one or more processors, the processing system configured to cause the UE to:
receive, from a network node, control information scheduling a first transport block and indicating that the first transport block has a same hybrid automatic repeat request (HARQ) identifier as a second transport block;
identify an unsuccessful termination of a HARQ process associated with the second transport block in response to a failure of the UE to successfully decode the second transport block, the control information scheduling the first transport block having the same HARQ identifier as the second transport block, or both; and
transmit, to the network node, signaling indicating the unsuccessful termination of the HARQ process associated with the second transport block.

2. The UE of claim 1, wherein the control information scheduling the first transport block indicates a change in value of a new data indicator associated with the same HARQ identifier.

3. The UE of claim 1, wherein, to cause the UE to transmit the signaling indicating the unsuccessful termination of the HARQ process, the processing system is configured to cause the UE to transmit the signaling in response to a quantity of retransmissions associated with the second transport block being less than a threshold.

4. The UE of claim 3, wherein the processing system is further configured to cause the UE to:
receive, from the network node, second signaling indicating the threshold.

5. The UE of claim 1, wherein the processing system is further configured to cause the UE to:
transmit, to the network node prior to receiving the control information scheduling the first transport block, a HARQ negative acknowledgement (NACK) associated with the second transport block.

6. The UE of claim 5, wherein the processing system is further configured to cause the UE to:
initiate a timer in response to transmitting the HARQ NACK associated with the second transport block, wherein to cause the UE to transmit the signaling indicating the unsuccessful termination of the HARQ process, the processing system is configured to cause the UE to transmit the signaling in response to an expiration of the timer.

7. The UE of claim 6, wherein, to cause the UE to transmit the signaling indicating the unsuccessful termination of the HARQ process, the processing system is configured to cause the UE to transmit the signaling prior to receiving the control information from the network node.

8. The UE of claim 6, wherein the processing system is further configured to cause the UE to:
reset the timer in response to receiving second control information scheduling the second transport block, wherein the timer is associated with the same HARQ identifier, and wherein, to cause the UE to reset the timer, the processing system is configured to cause the UE to reset the timer in response to receiving any control information scheduling transport blocks associated with the same HARQ identifier.

9. The UE of claim 1, wherein the processing system is further configured to cause the UE to:
receive, from the network node, a third transport block having the same HARQ identifier as the first transport block; and
transmit, to the network node prior to receiving the control information scheduling the first transport block, a HARQ acknowledgement (ACK) or a HARQ negative ACK (NACK) associated with the third transport block, wherein, to cause the UE to identify the unsuccessful termination of the HARQ process, the processing system is configured to cause the UE to identify the unsuccessful termination of the termination of the HARQ process in response to a first new data indicator associated with the first transport block and a second new data indicator associated with the third transport block.

10. The UE of claim 9, wherein, to cause the UE to identify the unsuccessful termination of the HARQ process, the processing system is configured to cause the UE to identify the unsuccessful termination of the HARQ process in response to the first new data indicator being different from the second new data indicator.

11. The UE of claim 10, wherein:
the first new data indicator and the second new data indicator each comprise two or more bits; and
a difference between a first value associated with the first new data indicator and a second value associated with the second new data indicator is two or more.

12. The UE of claim 11, wherein the processing system is further configured to cause the UE to:
identify a second unsuccessful termination of a second HARQ process associated with the third transport block in response to a failure of the UE to successfully decode the third transport block and the difference being two or more; and
transmit, to the network node, the HARQ NACK associated with the third transport block, wherein the signaling indicating the unsuccessful termination of the HARQ process further indicates the second unsuccessful termination of the second HARQ process.

13. The UE of claim 12, wherein the HARQ process and the second HARQ process are associated with a same HARQ identifier.

14. The UE of claim 9, wherein, to cause the UE to identify the unsuccessful termination of the HARQ process, the processing system is configured to cause the UE to identify in response to transmitting the HARQ ACK associated with the third transport block and the first new data indicator and the second new data indicator being the same.

15. The UE of claim 14, wherein, to cause the UE to identify the unsuccessful termination of the HARQ process, the processing system is configured to cause the UE to identify in response to:
a first transport block size indicated by the control information being different from a second transport block size associated with the third transport block;
a modulation and coding scheme indicated by the control information failing to comprise a reserved value for a coding rate for the first transport block;
the control information scheduling an initial transmission of the first transport block; or
the control information indicating a value of 0 for a redundancy version of the first transport block.

16. The UE of claim 1, wherein the signaling indicating the unsuccessful termination of the HARQ process comprises an identifier associated with the HARQ process and a new data indicator associated with the HARQ process.

17. The UE of claim 16, wherein the signaling indicating the unsuccessful termination of the HARQ process further comprises an index associated with a component carrier associated with the second transport block, an indication of a time associated with the unsuccessful termination of the HARQ process, or both.

18. The UE of claim 1, wherein:
the signaling indicating the unsuccessful termination of the HARQ process comprises a bitmap associated with a plurality of HARQ process identifiers; and
a value of a bit in the bitmap associated with the HARQ process indicates the unsuccessful termination of the HARQ process.

19. The UE of claim 18, wherein the signaling indicating the unsuccessful termination of the HARQ process further comprises a new data indicator associated with the HARQ process, an indication of a time associated with the unsuccessful termination of the HARQ process, or both.

20. The UE of claim 18, wherein the signaling indicating the unsuccessful termination of the HARQ process comprises multiple bitmaps that are each associated with a different component carrier.

21. The UE of claim 1, wherein:
the same HARQ identifier is associated with a first new data indicator and a second new data indicator; and
the signaling indicating the unsuccessful termination of the HARQ process comprises an acknowledgement (ACK) or NACK for each of the first new data indicator and the second new data indicator.

22. The UE of claim 1, wherein, to cause the UE to transmit the signaling indicating the unsuccessful termination of the HARQ process, the processing system is configured to cause the UE to transmit the signaling via uplink control information, a media access control control element, or a radio link control status report.

23. The UE of claim 1, wherein the processing system is further configured to cause the UE to:
receive, from the network node, signaling indicating for the UE to report, to the network node, unsuccessful terminations of HARQ processes, wherein, to cause the UE to transmit the signaling indicating the unsuccessful termination of the HARQ process, the processing system is configured to cause the UE to transmit the signaling in response to receiving signaling indicating for the UE to report the unsuccessful terminations of HARQ processes.

24. The UE of claim 23, wherein the processing system is further configured to cause the UE to:
transmit, to the network node, a capability of the UE to report unsuccessful terminations of HARQ processes to the network node, wherein, to cause the UE to receive the signaling indicating for the UE to report unsuccessful terminations, the processing system is configured to cause the UE to receive the signaling indicating in response to transmitting the capability of the UE.

25. A network node for wireless communication, comprising:
a processing system that includes one or more processors and one or more memories coupled with the one or more processors, the processing system configured to cause the network node to:
transmit, to a user equipment (UE), control information scheduling a first transport block and indicating that the first transport block has a same hybrid automatic repeat request (HARQ) identifier as a second transport block; and
receive, from the UE, signaling indicating an unsuccessful termination of a HARQ process associated with the second transport block, wherein receiving the signaling is in response to a failure of the UE to successfully decode the second transport block, the control information scheduling the first transport block having the same HARQ identifier as the second transport block, or both.

26. The network node of claim 25, wherein the control information scheduling the first transport block indicates a change in value of a new data indicator associated with the same HARQ identifier.

27. The network node of claim 25, wherein, to cause the network node to receive the signaling indicating the unsuccessful termination of the HARQ process, the processing system is configured to cause the network node to receive the signaling in response to a quantity of retransmissions associated with the second transport block being less than a threshold.

28. The network node of claim 27, wherein the processing system is further configured to cause the network node to:
transmit, to the UE, second signaling indicating the threshold.

29. A method of wireless communication by a user equipment (UE), comprising:
receiving, from a network node, control information scheduling a first transport block and indicating that the first transport block has a same hybrid automatic repeat request (HARQ) identifier as a second transport block;
identifying an unsuccessful termination of a HARQ process associated with the second transport block in response to a failure of the UE to successfully decode the second transport block, the control information scheduling the first transport block having the same HARQ identifier as the second transport block, or both; and
transmitting, to the network node, signaling indicating the unsuccessful termination of the HARQ process associated with the second transport block.

30. A method of wireless communication by a network node, comprising:
transmitting, to a user equipment (UE), control information scheduling a first transport block and indicating that the first transport block has a same hybrid automatic repeat request (HARQ) identifier as a second transport block; and
receiving, from the UE, signaling indicating an unsuccessful termination of a HARQ process associated with the second transport block, wherein receiving the signaling is in response to a failure of the UE to successfully decode the second transport block, the control information scheduling the first transport block having the same HARQ identifier as the second transport block, or both.
